(19) United States
(12) Patent Application Publication
(10) Pub. No.: US 2005/0212915 A1
(43) Pub. Date: Sep. 29, 2005

(54) Digital camera

(75) Inventors: Toshihiko Karasaki, Kawachinagano-shi (JP); Hitoshi Hagimori, Ikoma-gun (JP); Yong Xin Huang, Kobe-shi (JP); Masahito Niikawa, Sakai-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA PHOTO IMAGING, INC.

(21) Appl. No.: 11/007,925

(22) Filed: Dec. 9, 2004

(30) Foreign Application Priority Data
Mar. 26, 2004 (JP) JP2004-092423

(51) Int. Cl. H04N 5/225; H04N 5/76

(52) U.S. Cl. 348/207.2; 348/231.99; 348/231.2; 348/333.02; 348/333.11; 348/220.1

(57) ABSTRACT

The present invention provides a digital camera capable of optimizing a timing of switching a display screen to a print setting screen including an image on which print settings are to be made. In a process of protecting or formatting a captured image in a playback mode, a process of recording a captured image in an image capturing mode, and the like, a request of a file access (writing) to a memory card is generated. In response to the request or the like, a state where a file in the memory card is protected from other accesses is set, and writing of the file starts. After that, writing of the file is completed, and various accesses to the file in the memory card are permitted. That is, during a file access (writing), in response to depression of a print button, an operation of reading an image file in the memory card and switching to a print mode is inhibited.

This application is based on application No. JP2004-092423 filed in Japan, the contents of which are hereby incorporated by reference.

### BACKGROUND OF THE INVENTION

1. Field of the Invention

The present invention relates to a technique for making a print setting on a captured image in a digital camera.

2. Description of the Background Art

In recent years, a digital camera has been rapidly spread and a technique capable of directly outputting an image captured by a digital camera via a removable memory has been realized. As a file format for recording print setting data of a captured image into a removable memory, a DPOF (Digital Print Order Format) (trademark) is known.

In such a digital camera, however, a very complicated operation is generally required to make a print setting on a captured image. A technique capable of making a print setting on a display image only by depressing a switch dedicated to the DPOF while a captured image (still image) is being displayed on a display has been proposed. In the technique, depression of the DPOF dedicated switch effectively functions during display of a still image, in which an image on which a print setting is to be made is identifiable.

However, for example, in the case where a print setting screen showing a target image and on which a print setting can be made is displayed in response to a I) predetermined operation, when a file access is made for reading an image file for displaying the print setting screen during updating of the image file to be stored in a memory card, the image file is not accurately updated due to conflict of file accesses and it causes a problem such that the image file is substantially destroyed. Consequently, in the case where a predetermined process is being executed, timings at which a display screen on a display should not be switched to the print setting screen exist.

In the above-described proposed technique, timings at which the display screen should not be switched to the print setting screen are not considered.

### SUMMARY OF THE INVENTION

The present invention is directed to a digital camera capable of making print settings on a captured image which is recorded on a recording medium.

According to the present invention, the digital camera capable of setting a print condition on a captured image which is stored in a storage medium comprises: a display part capable of displaying the captured image; a manual operation part which accepts a manual operation for switching a camera status from a current operation mode to a print mode for setting a print condition on the captured image; and a controller which switches a status of the display part from a current mode to a print condition setting mode in response to the manual operation, wherein the print condition setting mode is such that the captured image is displayed on the display part together with an information element for designating the print condition for the captured image. The controller comprises a first control element operable to determine whether or not a file access for a process for other than the print condition setting mode is being executed to a file including the captured image in the storage medium, and a second control element operable to inhibit a switch of the status of the display part to the print condition setting mode during execution of the file access.

Since conflict of file accesses can be prevented, inconveniences such as destroy of a file can be prevented. That is, the timing of a switch to the print setting screen can be optimized.

According to another aspect of the present invention, the digital camera capable of setting a print condition on a captured image which is stored in a storage medium comprises: a display part capable of displaying the captured image; a manual operation part which accepts a manual operation for switching a camera status from a current operation mode to a print mode for setting a print condition on the captured image; and a controller which switches a status of the display part from a current mode to a print condition setting mode in response to the manual operation, wherein the print condition setting mode is such that the captured image is displayed on the display part together with an information element for designating the print condition for the captured image. The controller comprises a first control element operable to determine whether or not a file access for a process for other than the print condition setting mode is being executed to a file including the captured image in the storage medium, a second control element operable to inhibit a switch of the status of the display part to the print condition setting mode during execution of the file access, a third control element operable to store the manual operation, and a fourth control element operable to detect completion of the file access, and then switch the status of the display part to the print condition setting mode in response to the manual operation stored.

Since conflict of file accesses can be prevented, inconveniences such as destroy of a file can be prevented. That is, the timing of a switch to the print setting screen can be optimized.

The present invention is also directed to a digital camera capable of printing out a captured image which is recorded on a recording medium via a connected printer.

It is therefore an object of the present invention to provide a digital camera capable of optimizing a timing of switching a display screen to a print setting screen including an image on which print settings are to be made.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing the outside configuration of a digital camera according to a preferred embodiment of the present invention;

FIG. 2 is a diagram showing the outside configuration of the digital camera;

FIG. 3 is a diagram showing the inside configuration of the digital camera;

FIG. 4 is a diagram showing a data sequence in a memory card;

FIGS. 5 and 6 are diagrams respectively illustrating a print order file;

FIGS. 7 and 8 are diagrams respectively illustrating a print setting screen;

FIGS. 9 to 12 are diagrams respectively showing operations in a print mode;

FIG. 13 is a diagram illustrating an enlarged print preview screen;

FIG. 14 is a flowchart showing operations of print order recording;

FIG. 15 is a state transition diagram showing basic operations of the digital camera;

FIG. 16 is a diagram showing the relation between the print mode and other four kinds of modes;

FIG. 17 is a flowchart showing error check operation;

FIG. 18 is a diagram showing processes performed in the case where the print button is depressed in the states of the digital camera in the playback mode;

FIG. 19 is a flowchart showing an operation flow of switching to the print mode during a file access (reading);

FIG. 20 is a flowchart showing an operation flow of ignoring an operation of depressing a print button 13 during a file access (writing);

FIG. 21 and FIG. 22 are diagrams respectively showing operations of the digital camera in a playback mode;

FIG. 23 is a diagram showing processes performed in the case where the print button is depressed in the states of the digital camera in an image capturing mode;

FIG. 24 is a flowchart showing an operation flow of switching the digital camera to the print mode during a file access (writing); and

FIG. 25 is a diagram showing operations of the digital camera in a single frame shooting mode.

### DESCRIPTION OF THE PREFERRED EMBODIMENTS

Hereinafter, preferred embodiments of the present invention will be described with reference to the drawings.

Outline of Configuration

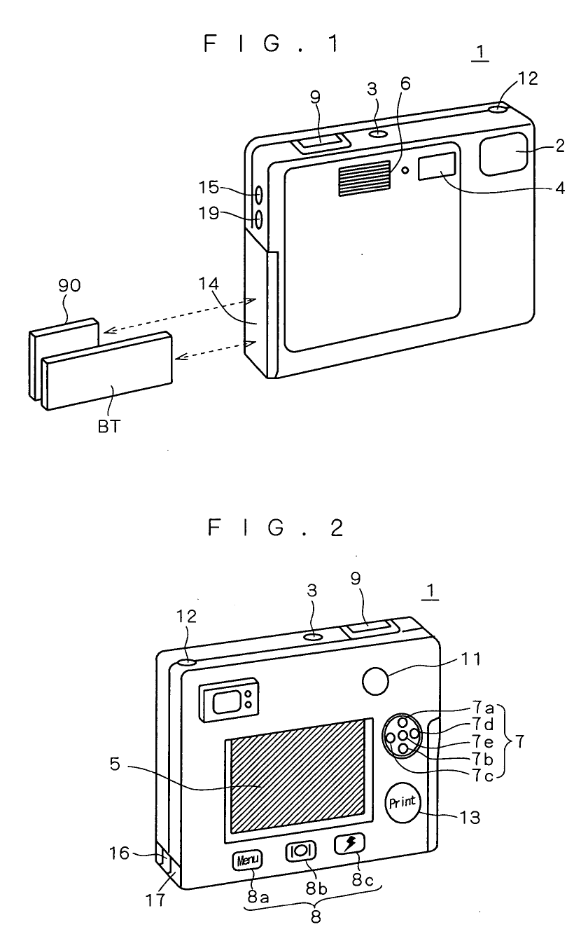

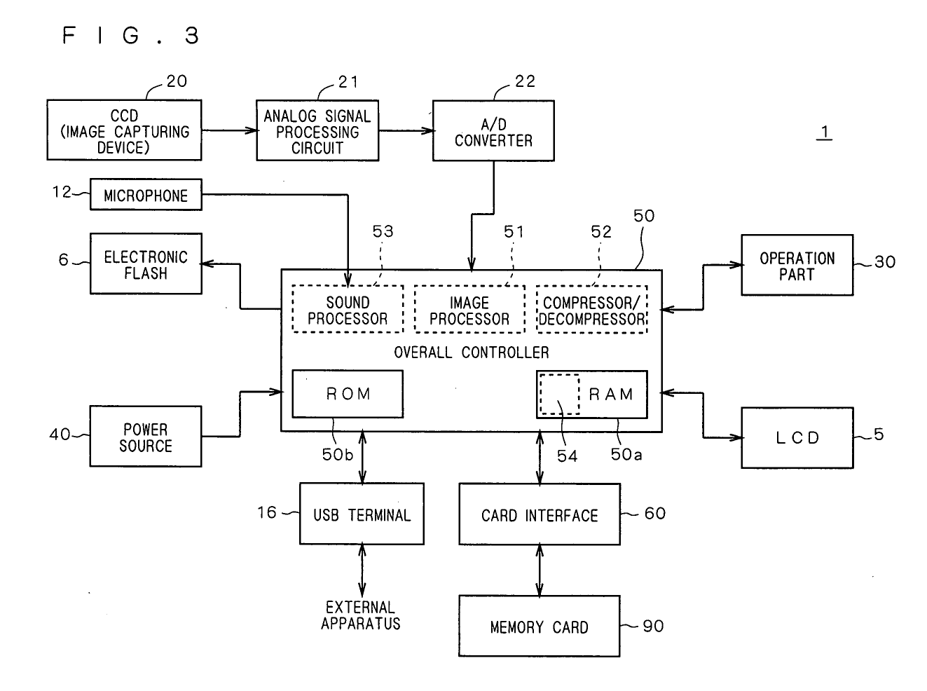

FIGS. 1 and 2 are diagrams respectively showing the outside configuration of a digital camera 1 according to a preferred embodiment of the present invention. FIG. 1 is a schematic perspective view from the front side and FIG. 2 is a schematic perspective view from the rear side.

As shown in FIGS. 1 and 2, the digital camera 1 is thin and has an almost rectangular parallelepiped shape.

As shown in FIG. 1, the digital camera 1 has, on its front face side, a taking lens 2, an optical viewfinder 4 and an electronic flash 6, and has, on its top face side, a power source button 3, a shutter button (release button) 9 and a microphone 12. As shown in FIG. 2, the digital camera 1 has, on its rear face side, a liquid crystal display (hereinafter, referred to as LCD) 5, button groups 7 and 8, a mode switching button 11 and a print button 13. The button group 7 is constructed by cross cursor buttons 7a to 7e (hereinafter, also referred to as up button 7a, down button 7b, left button 7c, right button 7d and center (execution) button 7e). The button group 8 has a menu button 8a, a liquid crystal monitor button 8b and an electronic flash mode button 8c. Further, as shown in FIGS. 1 and 2, the digital camera 1 also has, on its side faces, a cover 14, a DC input terminal 15, a USB terminal 16, an AV output terminal 17, and an access LED 19.

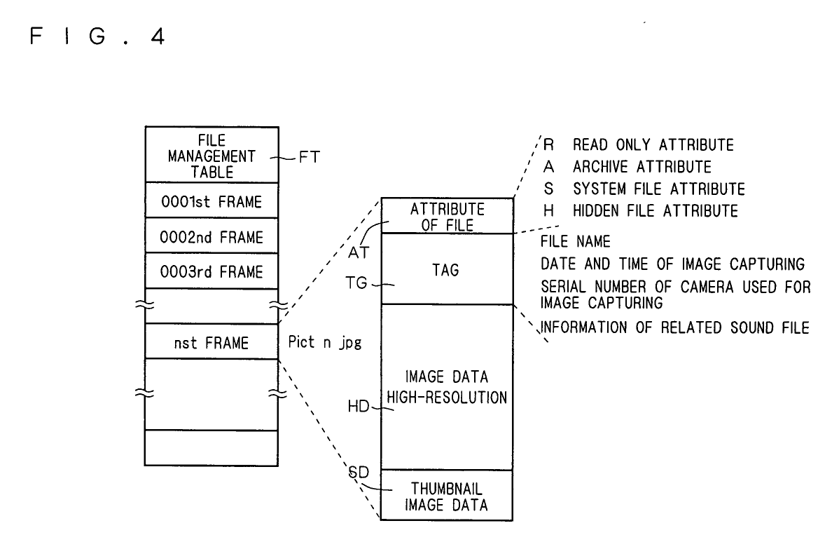

As will be described later, the digital camera 1 obtains image data of a subject by photoelectrically converting an image of the subject from the taking lens 2 by a CCD (Charge Coupled Device) 20 (FIG. 3).

The power source button 3 is used for accepting an operation of turning on/off the power source. Concretely, each time the power source button 3 is depressed, the power source is switched between the ON and OFF states.

The shutter button 9 is a two-level press switch capable of detecting a half-pressed state (hereinafter, also referred to as an S1 state) and a depressed state (hereinafter, also referred to as an S2 state) set by the user (operator). In the half-pressed (S1) state, automatic focus control is started. In the depressed (S2) state, image capturing operation for capturing an image to be recorded is started.

The LCD 5 performs preview display (also referred to as live view display) before the image capturing operation and playback and display of a recorded image. The LCD 5 has a predetermined number of display pixels (in this case, 320×240) and can display a color image.

After the power source of the digital camera 1 is turned on or the image capturing operation is completed, in the live view display, capturing of an image of the subject is repeated at low resolution every 1/30 second and the captured image is displayed in a motion picture mode on the LCD 5. By the live view display on the LCD 5, the user can perceive the position, size and the like of the subject in the captured image and perform framing operation. The framing operation can be also performed by using only the optical viewfinder 4 without using the LCD 5.

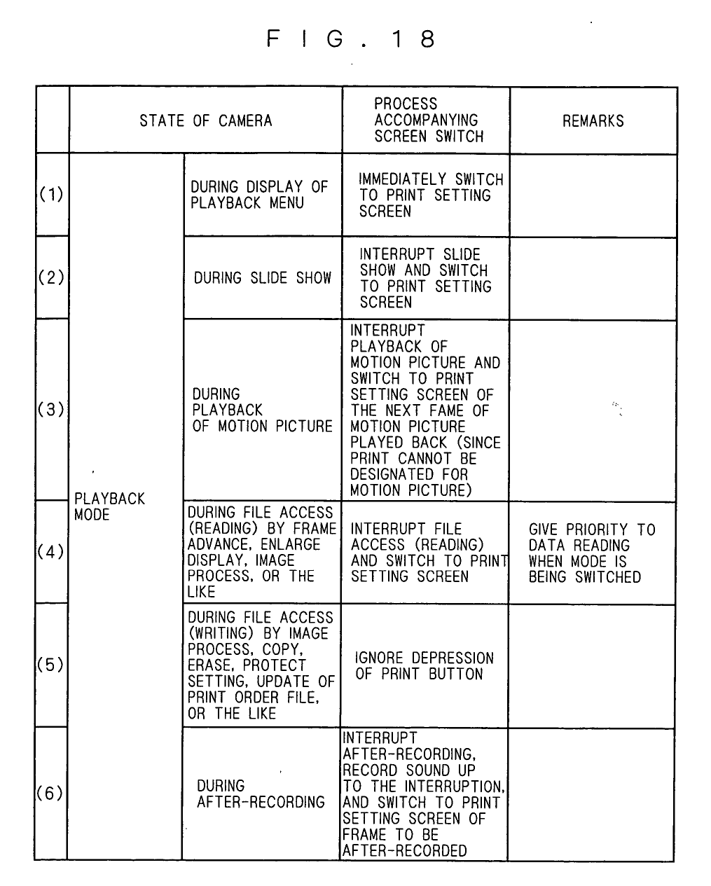

By depressing the mode switching button 11, the mode is cyclically switched among the single frame shooting mode, continuous shooting mode, motion picture mode and playback mode (see FIG. 16). The single frame shooting mode, continuous shooting mode and motion picture mode are included in the image capturing mode. The image capturing mode is capturing an image of a subject, and the playback mode is a mode of playing back a captured image recorded on a memory card and displaying the image played back on the LCD 5. The digital camera 1 of the preferred embodiment is set in the image capturing mode at the turn-on of the power source by depression of the power source button 3. By depressing the mode switching button 11, the mode can be switched to the playback mode. By further depressing the mode switching button 11, the mode is switched to the single frame shooting mode in the image capturing mode.

The menu button 8a has a function of switching between display and non-display of a menu on the LCD 5. For example, each time the menu button 8a is depressed in the initial screen of any operation mode, a menu screen and a screen without a menu (display screen of a live view, an image played back or the like) are alternately displayed on the LCD 5. A display cursor in the menu screen displayed on the LCD 5 can be moved in four ways by using the cross cursor buttons 7a to 7d. Further, by depressing the execution (center) button 7e in the state where a desired option is selected, a setting operation or the like corresponding to the option can be executed. By such operation, various image capturing parameters can be set.

The liquid crystal monitor button 8b is a button for switching the state between display and non-display of an image on the LCD 5 as a liquid crystal monitor. Each time the liquid crystal monitor button 8b is depressed, a state where an image or the like is displayed (display state) and a state where no image is displayed (non-display state) are alternately switched. In the non-display state, power consumption can be decreased.

The electronic flash mode button 8c is a button for determining the mode of the electronic flash 6. Each time the electronic flash mode button 8c is depressed, the electronic flash mode is switched to an automatic electronic flash mode, a forced electronic flash mode and an electronic flash inhibited mode in this order.

The microphone 12 is used for obtaining (recording) sound data at the time of motion picture capturing, voice memo, voice recording and after-recording.

The print button 13 is a button for switching the mode to a print mode (which will be described later). Specifically, the print button 13 accepts an operation of switching a status of the digital camera (also referred to as a camera status) to a print mode for making a print setting on a captured image (also referred to as a print setting operation). In this case, in response to an operation of depressing the mode switching button 11 or the print button 13, a mode is switched among a plurality of modes including the image capturing and playback mode and the print mode by the overall controller 50.

The cover 14 is provided in a portion to cover a battery chamber and a memory card insertion part. In other words, on the inside of the cover 14, a battery chamber for housing a power source battery BT and a memory card insertion part in which a memory card 90 as a removable recording medium (portable storage medium) is inserted are provided. The power source battery BT and the memory card 90 are detachably inserted in the battery chamber and the memory card insertion part, respectively. Image data and the like obtained by the image capturing operation is recorded on the memory card 90 which is inserted into the insertion part. The digital camera 1 can receive power supply from the power source battery BT and power supply from an AC adapter (not shown) or the like by using the DC input terminal 15.

The USB terminal 16 is a terminal for performing data communication with a personal computer. By connecting a USB standard cable or the like to the USB terminal 16, data communication can be performed with an external apparatus (personal computer or the like).

The AV output terminal 17 is a terminal for connecting the digital camera 1 to an external audio visual apparatus (AV apparatus) such as a television. By connecting the AV output terminal 17 and an input terminal of the external AV apparatus via a predetermined AV code, an image and/or sound can be outputted to the external AV apparatus.

The access LED 19 indicates a state where a file is being written to/read from the memory card 90, that is, a file is being accessed. During an access to a file, the access LED 19 lights up.

The inside configuration of the digital camera 1 will now be described with reference to FIG. 3. FIG. 3 is a block diagram showing the internal functions of the digital camera 1.

The CCD (image capturing device) 20 functions as image capturing means for capturing an image of a subject and generating an electronic image signal and has, for example, 1600×1200 pixels. The CCD 20 photoelectrically converts a light image of the subject formed by the taking lens 2 into an image signal of color components of R (red), G (green) and B (blue) on a pixel unit basis (signal constructed by a signal sequence of pixel signals received by the pixels) and outputs the image signal.

The image signal obtained from the CCD 20 is supplied to an analog signal processing circuit 21 where the image signal (analog signal) is subjected to predetermined analog signal processes. The analog signal processing circuit 21 has a correlated double sampling (CDS) circuit and an auto gain control (AGC) circuit. A process of reducing noise in the image signal is performed by the CDS circuit and the gain is adjusted by the AGC circuit, thereby performing level adjustment of the image signal.

An A/D converter 22 converts each of pixel signals of the image signal into a digital signal of 12 bits. The digital signal obtained by the conversion is temporarily stored as image data into a buffer memory 54 in an RAM 50a. On the image data stored in the buffer memory 54, WB (White Balance) process, y correcting process, color correcting process and the like are performed by an image processor 51 which will be described later, and the processed data is subjected to compressing process or the like in a compressor/decompressor 52.

A sound signal obtained from the microphone 12 is inputted to a sound processor 53. The sound signal inputted to the sound processor 53 is converted by an A/D converter (not shown) provided in the sound processor 53 into a digital signal, and the digital signal is temporarily stored in the buffer memory 54.

An operation part 30 is an operation part including the power source button 3, button groups 7 and 8, shutter button 9 and mode switching button 11 and is used by the user to perform an operation of changing the setting state of the digital camera 1, an image capturing operation, and the like.

A power source 40 is a power supply source for the digital camera 1. The digital camera 1 is driven by using a secondary battery such as a lithium ion battery as the power source battery BT.

An overall controller 50 is constructed by a microcomputer having therein the RAM 50a and a ROM 50b and controls the above-described components in a centralized manner when the microcomputer executes a predetermined program. The RAM 50a is a semiconductor memory which can be accessed at high speed (for example, DRAM). The ROM 50b is an electrically rewritable nonvolatile semiconductor memory (for example, a flash ROM). A region in a part of the RAM 50a functions as a buffer area for temporary storage. Herein, the buffer area is also referred to as the buffer memory 54. The buffer memory 54 temporarily stores image data and sound data.

The overall controller 50 has the image processor 51, compressor/decompressor 52 and sound processor 53. The processors 51, 52 and 53 are a function part realized when the microcomputer executes a predetermined program.

The image processor 51 is a processor for performing various digital image processes such as WB process and y correcting process. The WB process is a process for performing level conversion of each of the color components of R, G and B and adjusting color balance. The y correcting process is a process for correcting the tone of pixel data. The compressor/decompressor 52 is a processor for performing a process of compressing/decompressing image data. As a compressing method, for example, the JPEG system is employed. The sound processor 53 is a processor for performing various digital processes on sound data.

By the overall controller 50 having such a configuration, processes are performed in the image capturing mode, playback mode and print mode. For example, when the shutter button 9 is half-pressed (S1 state) by the user in the image capturing mode, an AF evaluation value is obtained on the basis of image data outputted from the CCD 20, and the taking lens is moved to a focus position by a known hill-climbing method. On the basis of luminance information of the subject read by the CCD 20, shutter speed, an f-number value, and a gain set value of auto white balance at the time of image capturing are determined.

On the other hand, when the shutter button is depressed (S2 state) in the image capturing mode, the overall controller 50 sets the resolution of the CCD 20 to high resolution, captures an image of a subject, and generates a compressed image by the compressor/decompressor 52 on the basis of image data captured by the CCD 20. The compressed high-resolution image data is recorded on the memory card 90 functioning as a recording medium. The data structure in the memory card 90 will be described below.

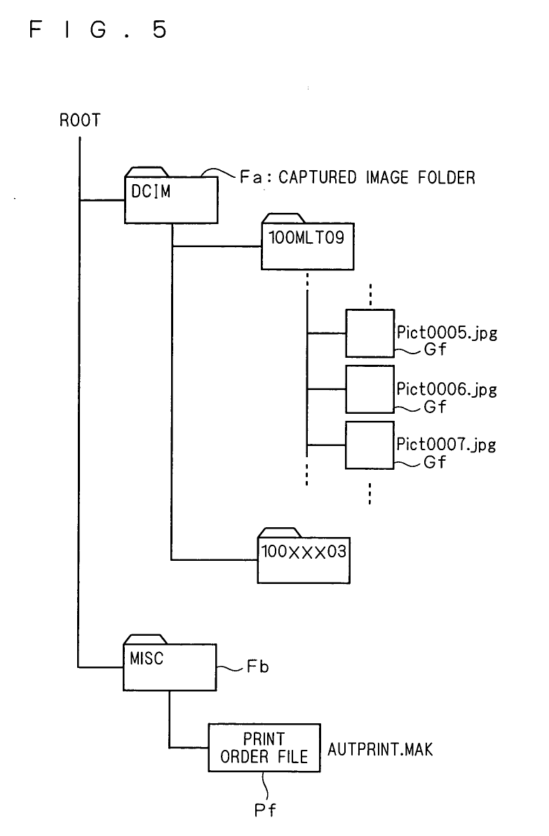

FIG. 4 is a diagram showing a data sequence of the memory card 90. In the memory card 90, frames of a still picture and a motion picture recorded by the digital camera 1 are stored sequentially. In each frame, a file attribute AT, tag information TG, high-resolution image data HD (1600×1200 pixels) compressed in the JPEG format, and thumbnail image data SD (320×240 pixels) for displaying a thumbnail image are recorded. In the file attribute AT, read only attribute (R), archive attribute (A), system file attribute (S) and hidden file attribute (H) can be set. In the case where protection of a file is set by the user, the read only attribute is set. In the tag TG, information of file name, date and time of image capturing, serial number of a digital camera used for the image capturing, and sound file associated with image data is recorded.

When the image capturing mode is switched to the playback mode by depression of the mode switching button 11, data of an image of the largest frame number in the memory card 90, that is, an image captured most recently is read and decompressed by the compressor/decompressor 52, and the resultant image is displayed on the LCD 5. In the playback mode, the frame advance and frame reverse can be performed by depression of the left button 7c and the right button 7d, respectively.

A card interface (I/F) 60 is an interface for writing/reading image data to/from the memory card 90 inserted in the insertion part in the side face of the digital camera 1.

At the time of reading/writing image data from/to the memory card 90, the process of compressing/decompressing image data is performed in, for example, the JPEG system by the compressor/decompressor 52 and image data is transmitted/received between the buffer memory 54 and the memory card 90 via the card interface 60. Also at the time of reading/writing sound data, sound data is transmitted/received between the buffer memory 54 and the memory card 90 via the card interface 60.

Reading and writing on an image file in the memory card 90 is executed on the basis of a table (file management table) FT in which information for managing a data file in the memory card 90 is stored. For example, when reading of image data in the memory card 90 is requested, an image file is accessed by referring to information in the file management table FT, thereby executing reading of image data. On the other hand, when writing of image data to the memory card 90 is requested, creation of an image file or the like is executed, and information in the file management table FT is updated.

Further, by using the card interface 60, the digital camera 1 can perform not only transmission/reception of data such as an image and sound but also reception of a program which operates on the digital camera 1. For example, a control program recorded on the memory card 90 can be stored into the RAM 50a or ROM 50b in the overall controller 50. Consequently, the control program can be updated.

Also by communication with an external apparatus (such as an external computer) via the USB terminal 16, various data such as an image and sound, a control program or the like can be transmitted/received. For example, various data, a program or the like recorded on a recording medium (such as CD-R/RW or CD-ROM) set in a reading device (such as an optical drive device) of an external computer can be obtained via the USB terminal 16.

Print Mode

When the print button 13 is depressed by the user, the digital camera 1 enters the print mode for performing print settings, and a print setting screen is displayed. Specifically, the overall controller 50 switches the display screen on the LCD 5 to the print setting screen in response to an operation of depressing the print button 13 by the user. When the print setting screen is displayed on the LCD 5, print settings on a captured image included in the print setting screen can be made. In other words, the overall controller 50 switches a status of the LCD 5 from a current mode to a mode for setting a print condition on a captured image (also referred to as a print condition setting mode).

In the print mode, a print order file regarding print settings (also referred to as a print condition) is created. The print order file will be described first.

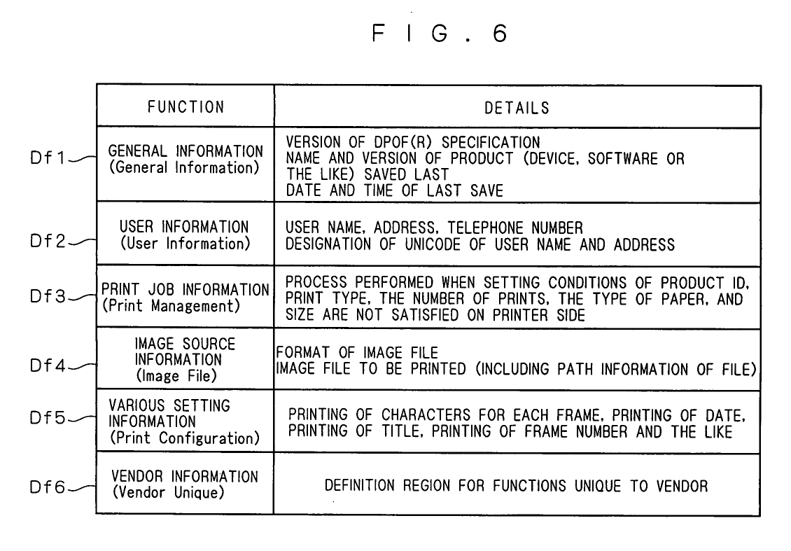

FIG. 5 is a diagram for describing a print order file Pf.

In the memory card 90, a plurality of image files Gf are stored in a captured image folder Fa and the print order file Pf is stored in a folder Fb different from the captured image folder Fa.

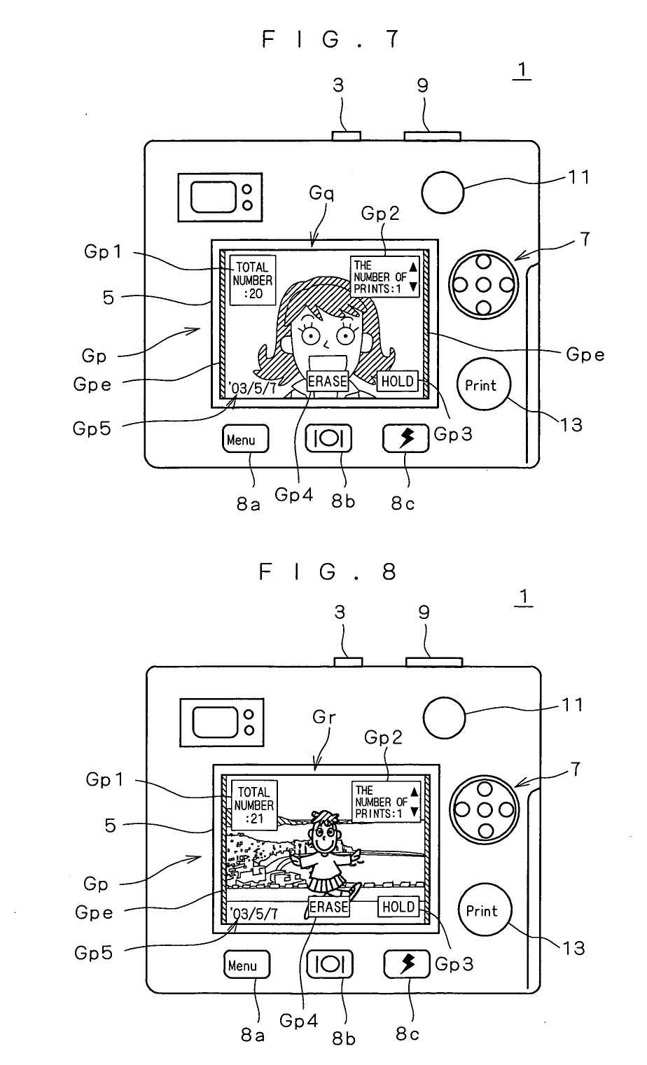

The print order file Pf is constructed by, as shown in FIG. 6, general information Df1, user information Df2, print job information Df3, image source information Df4, various settings information Df5 and vendor information Df6. The vendor information Df6 is information which is defined by each of manufactures of digital cameras.

By creating the print order file Pf, labor of the user at the time of print order can be reduced. The print setting screen for setting the various information Df1 to Df6 in the print order file Pf will now be described.

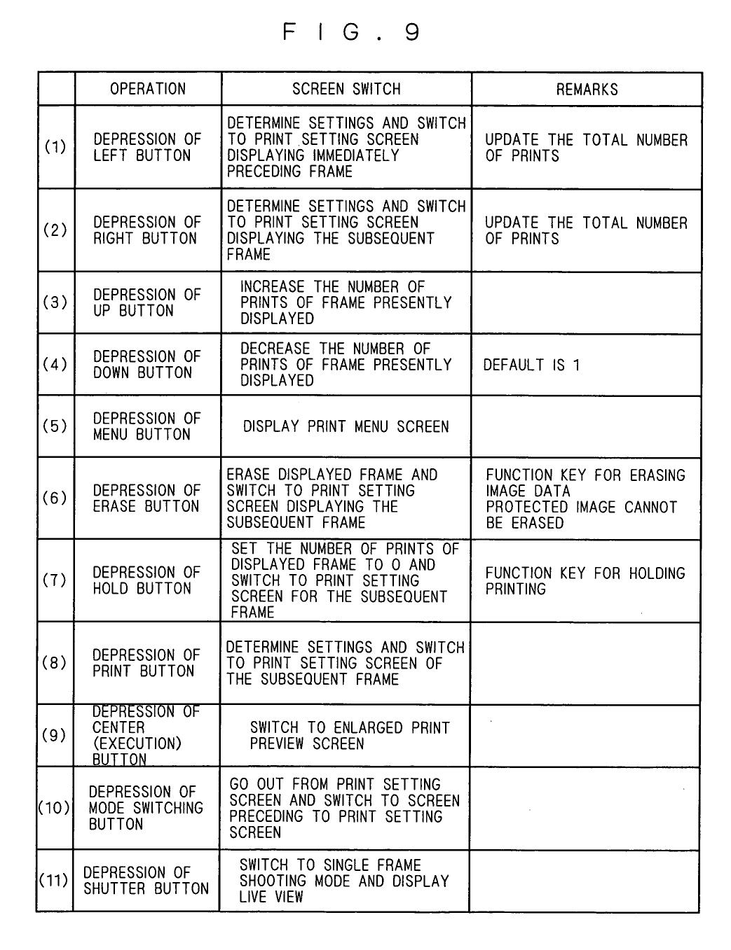

FIG. 7 is a diagram for describing the print setting screen.

In a print setting screen Gp displayed on the LCD 5, total number display Gp1 for displaying the total number of images ordered to be printed and order number display Gp2 for displaying the number of prints ordered of an image presently displayed on the LCD 5 are performed so as to superimpose on an image Gq to be printed. In short, the print setting screen displayed on the LCD 5 is a screen including display of a captured image as a target of print settings and various information on print settings.

On the other hand, when the digital camera 1 switched to the print mode in response to depression of the print button 13, the electronic flash mode button 8c functions as a hold button, and the liquid crystal monitor button 8b functions as an erase button. In the print setting screen Gp, “hold” display Gp3 and “erase” display Gp4 for indicating that the functions are assigned are performed.

In the digital camera 1, in order to give priority to a print image, the image Gq is displayed in accordance with the aspect ratio of the print size. When the aspect ratio of the screen size of the LCD 5 and that of the print size are different from each other, for example, the size is adjusted by providing margins Gpe (parallel hatched parts) in both ends of the screen of the LCD 5. In the case of superimposing the date of image capturing on the image Gq, date display Gp5 such as “'03/5/7/” is made in a superimpose portion of the image.

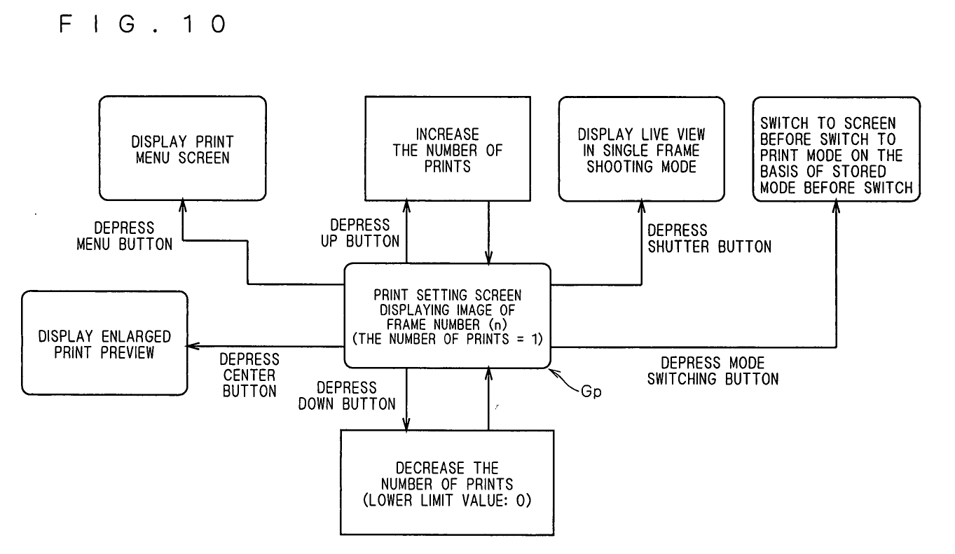

In the print setting screen Gp shown in FIG. 7, when the right button 7d or print button 13 is depressed, the subsequent image (frame) Gr is displayed as shown in FIG. 8 (to be described in detail later).

The operations in the print mode will now be described.

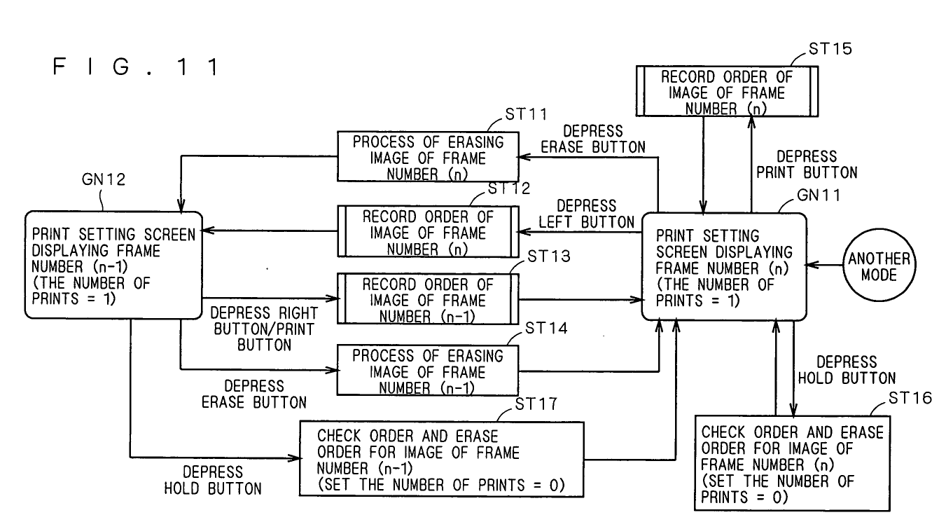

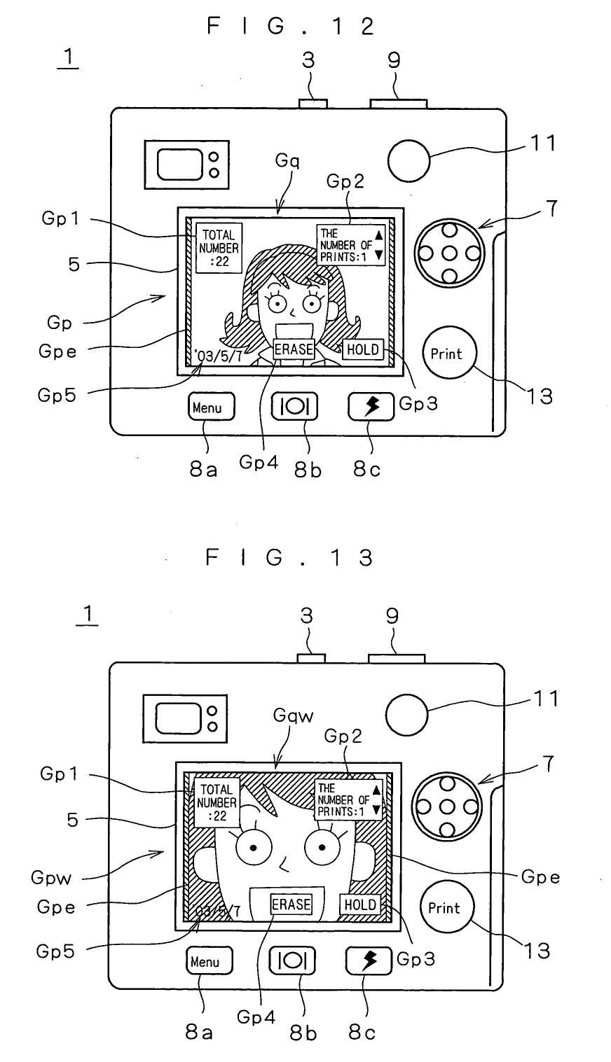

FIGS. 9 to 11 are diagrams for describing operations in the print mode for displaying the print setting screen Gp (FIG. 7) on the LCD 5. FIG. 9 shows the relation between the operation of the user and the screen transition and each of FIGS. 10 and 11 shows a state of transition from a print setting screen GN11 displaying an image of the frame number (n) to another screen. In the following description, the image of the frame number (n) will be regarded as an image having the latest (largest) frame number immediately after switch to the print mode. In FIG. 11, blocks having reference symbols starting with GN indicate states of the display screen, and blocks having reference symbols starting with ST show operations of the digital camera 1.

In the following, the operations of the print mode will be described with reference to FIGS. 10 and 11 for each of items (1) to (11) shown in FIG. 9.

(1) When the left button 7c is depressed, the settings made in the print setting screen are determined and the program switches to the print setting screen displaying the immediately preceding frame. In this case, the print order number selected in the image before depression of the left button 7c is added to the print total number, and the total number is updated.

Specifically, in the case where the left button 7c is depressed in the print setting screen GN11 displaying an image of the frame number (n) shown in FIG. 11, a process ST12 (which will be described in detail later) of recording the print order of the image of the frame number (n) is performed, and the program switches to a print setting screen GN12 of the image of the frame number (n−1).

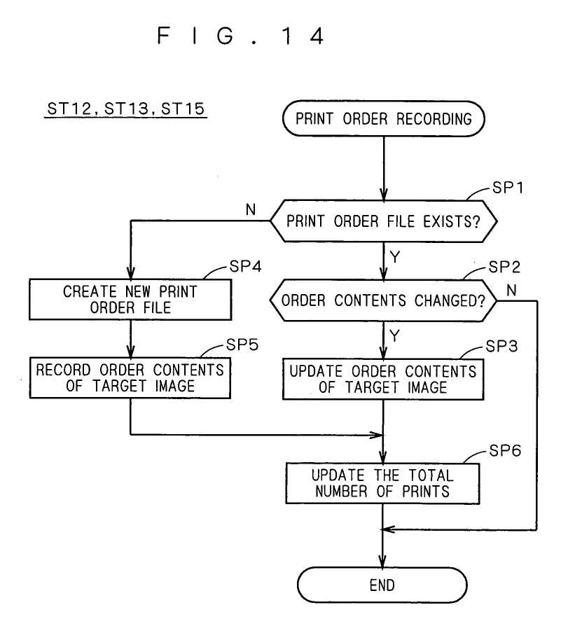

Concretely, for example, when the left button 7c is depressed in the state where the print setting screen Gp is displayed as shown in FIG. 8, as shown in FIG. 12, the image Gq corresponding to the immediately preceding frame is displayed on the LCD 5 and, in the total number display Gp1, the total number “22” obtained by increasing “21” in the total number display Gp1 of FIG. 8 by one is displayed.

(2) When the right button 7d is depressed, settings in the print setting screen are determined and the program switches to the print setting screen displaying the subsequent frame. In this case, the print order number selected in the image before depression of the right button 7d is added to the print total number, and the total number is updated.

Specifically, when the right button 7d is depressed in the print setting screen GN12 displaying the image of the frame number (n−1) shown in FIG. 11, a process ST13 (which will be described in detail later) of recording the print order of the image of the frame number (n−1) is performed, and the program switches to the print setting screen GN11 of the image of the frame number (n).

Concretely, for example, when the right button 7d is depressed in the state where the print setting screen Gp is displayed as shown in FIG. 7, as shown in FIG. 8, an image Gr corresponding to the subsequent frame is displayed on the LCD 5, and the total number “21” obtained by increasing “20” shown in the total number display Gp1 of FIG. 7 by one is displayed in the total number display Gp1.

(3) When the up button 7a is depressed, as shown in FIG. 10, the number of prints of the frame (image) which is currently displayed on the LCD 5 is increased. Therefore, the number in the print number display Gp2 increases.

(4) When the down button 7b is depressed, as shown in FIG. 10, the number of prints of the frame (image) which is currently displayed on the LCD 5 is decreased. Therefore, the number in the print number display Gp2 decreases. The default value of the number of prints is set as 1 and the lower limit value of the print number is 0.

(5) When the menu button 8a is depressed, as shown in FIG. 10, the print menu screen for making various settings on printing is displayed on the LCD 5.

(6) When the erase button 8b is depressed, the frame (image) which is currently displayed on the LCD 5 is erased, and the program switches to the print setting screen displaying the subsequent frame. The erase button 8b functions as a function key for erasing captured image data. However, even when the erase button 8b is depressed, a protected image, concretely, an image which is set in the read only attribute in the file attribute shown in FIG. 4 cannot be erased.

For example, when the erase button 8b is depressed in the print setting screen GN12 displaying the image of the frame number (n−1) shown in FIG. 11, a process ST14 of erasing the image of the frame number (n−1) is performed, and the program switches to the print setting screen GN11 displaying the image of the frame number (n).

When the erase button 8b is depressed in the print setting screen GN11 displaying the image of the maximum frame number (n) shown in FIG. 11, a process ST11 for erasing the image of the frame number (n) is performed and, after that, the program switches to the print setting screen GN12 displaying an image of the maximum frame number (n−1) after the erasing process.

(7) When the hold button 8c is depressed, the number of prints of the frame (image) currently displayed on the LCD 5 is set to 0, and the program switches to the print setting screen displaying the subsequent frame.

Specifically, when the hold button 8c is depressed in the print setting screen GN12 displaying the image of the frame number (n−1) shown in FIG. 11, the print order contents regarding the image of the frame number (n−1) are checked. When the print order number is 1 or more, a process ST17 for erasing the order contents regarding the image of the frame number (n−1), that is, for setting the number of prints to 0 is performed. The program switches to the print setting screen GN11 displaying the image of the frame number (n).

In the case where the hold button 8c is depressed in the print setting screen GN11 displaying the image of the frame number (n) shown in FIG. 11, the order contents in the print order file regarding the image of the frame number (n) are checked. When the print order number is 1 or more, a process ST16 for erasing the order contents regarding the image of the frame number (n), that is, setting the number of prints to 0 is performed. Since the frame number (n) is the largest and the subsequent frame does not exist, the program returns to the print setting screen GN11 displaying the image of the frame number (n).

(8) When the print button 13 is depressed, the settings made in the print setting screen are determined, and the program switches to the print setting screen displaying the next frame.

Specifically, when the print button 13 is depressed in the print setting screen GN12 displaying the image of the frame number (n−1) shown in FIG. 11, the ordering process ST13 (which will be described in detail later) on the image of the frame number (n−1) is performed, and the program switches to the print setting screen GN11 displaying the image of the frame number (n).

Concretely, for example, when the print button 13 is depressed in the state where the print setting screen Gp of FIG. 7 is displayed, as shown in FIG. 8, the image Gr corresponding to the subsequent frame is displayed on the LCD 5 and the total number “21” obtained by increasing “20” in the total number display Gp1 of FIG. 7 by one is displayed in the total number display Gp1.

In the case where the print button 13 is depressed in the print setting screen GN11 displaying the image of the frame number (n) shown in FIG. 11, an ordering process ST15 (which will be described in detail later) on the image of the frame number (n) is executed. In this case, the frame number (n) is the largest and the next frame does not exist, so that the program returns to the print setting screen GN11 displaying the image of the frame number (n).

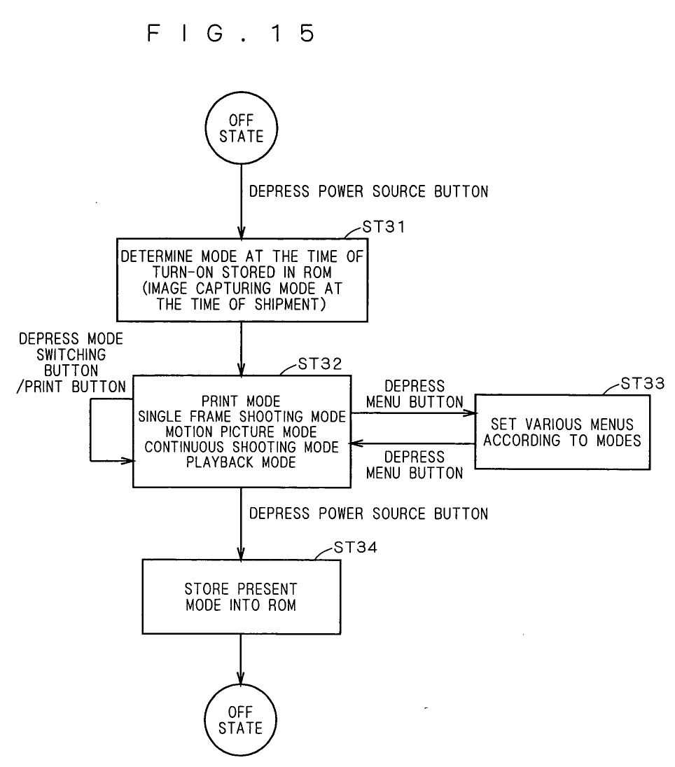

(9) When the center (execution) button 7e is depressed, the program switches to an enlarged print preview screen Gpw (see FIG. 13) as shown in FIG. 10. In the enlarged print preview screen Gpw, an image Gqw of which display magnification is, for example, twice as large as the print setting screen Gp (see FIG. 7) in which the image Gq of which display magnification is one is displayed while the print setting information such as the total number display Gp1 and the order number display Gp2 remains the same without being enlarged. The user can visually recognize the details of the image of the enlarged print preview screen Gpw.

(10) When the mode switching button 11 is depressed, the program goes out from the print setting screen as shown in FIG. 10 and switches to the screen (such as the menu screen of the image capturing mode) before the switch to the print setting screen on the basis of information of the switch source mode stored in the RAM 50a.

(11) When the shutter button 9 is depressed, as shown in FIG. 10, the program switches to the single frame shooting mode and the live view display is made.

The order recording operation in steps ST12, ST13 and ST15 in FIG. 11 will be described below.

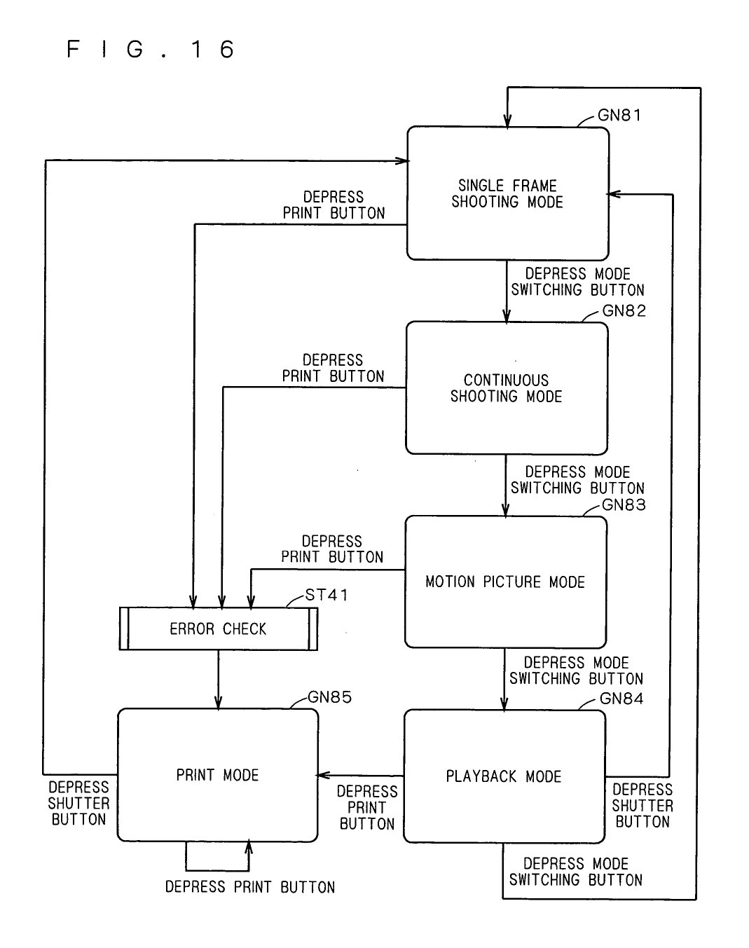

FIG. 14 is a flowchart showing the print order recording operation on an image of the frame number (n).

First, when the print button 13 or the like is depressed, it is determined whether the print order file exists in the memory card 90 or not (step SP1). In the case where a print order file exists, the program advances to step SP2. In the case where the print order file does not exist, the program advances to step SP4.

In step SP2, it is determined whether the order contents have been changed or not. For example, it is determined whether the number of prints has increased or not by depression of the up button 7a or down button 7b. If the order contents have been changed, the program advances to step SP3. If the order contents have not been changed, the program goes out from the flowchart and finishes the print order recording process.

In step SP3, the print order file is updated with the changed order contents of the image of the frame number (n) to be print ordered.

In step SP4, a print order file is newly created. Consequently, when the print button 13 is depressed and the program switches to the print mode, a print order file is created in the memory card 90.

In step SP5, the order contents of the image of the frame number (n) to be print ordered are recorded in the print order file.

In step SP6, the total number of prints is updated. Consequently, the total number display Gp1 in the print setting screen is changed.

In such a manner, print settings on a captured image recorded on the memory card 90 can be made.

In the digital camera 1, by depressing the left button 7c or the right button 7d, at least one print of a desired image can be ordered. Thus, an order omission can be prevented and the convenience of the user improves.

General Operation of Digital Camera 1

The operation regarding the print mode has been described above. The general operation of the digital camera 1 such as the relation between the print mode and the other modes (image capturing mode and playback mode) will be described below.

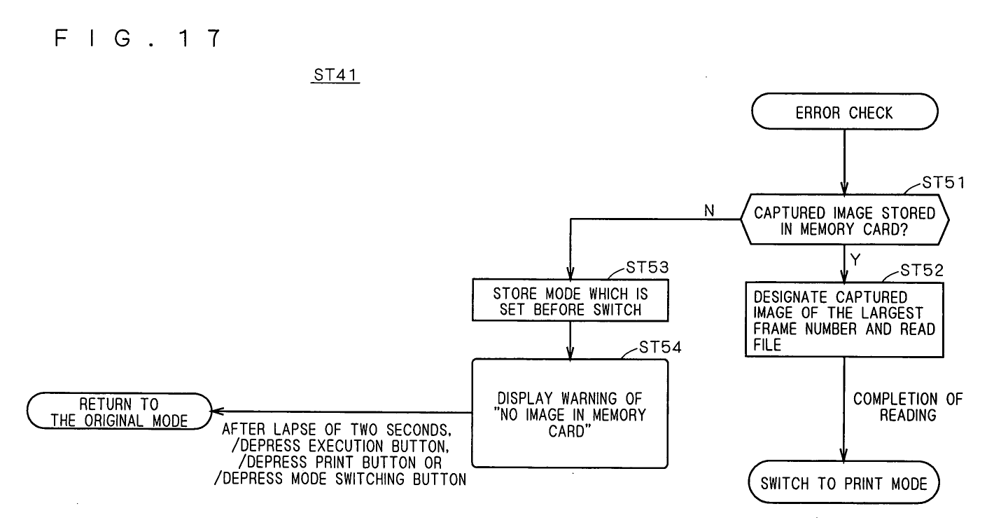

FIG. 15 is a state transition diagram showing basic operation of the digital camera 1.

First, when the power source button 3 is depressed in a state where the power source of the digital camera 1 is off, the program switches to a state ST31 of checking a mode at the time of turn-on stored in the ROM 50b. At the time of shipment of the digital camera 1, the image capturing mode is set.

The program switches to a state ST32 in which the mode determined in state ST31 is set. As the modes of the digital camera 1, there are the print mode, image capturing modes (single frame shooting mode, motion picture mode and continuous shooting mode) and playback mode. By depression of the mode switching button 11 and the print button 13, the mode can be switched among the five kinds of modes. In the case where the menu button 8a is depressed in the state ST32, the program switches to a state ST33 in which a screen for setting various menus according to the mode is displayed on the LCD 5.

On the other hand, when the power source button 3 is depressed in the state ST32, via a state ST34 for storing the currently set mode into the ROM 50b, the power source of the digital camera 1 is turned off.

The relation between the print mode as one of the five modes and the other four kinds of modes will be described with reference to FIG. 16 showing a state transition.

In states GN81 to GN84 in which the single frame shooting mode, continuous shooting mode, motion picture mode and playback mode are set, respectively, the mode is cyclically switched by depression of the mode switching button 11. At the time of switching the state GN83 in which the motion picture mode is set to the state GN84 in which the playback mode is set, a captured image of the largest frame number is displayed on the LCD 5.

When the print button 13 is depressed in the states GN81 to GN83 in which the single frame shooting mode, continuous shooting mode and motion picture mode are set, respectively, via an error check ST41 which will be described in detail later, the program switches to a state GN85 in which the print mode is set. Immediately after the switch to the state GN85, a captured image of the largest frame number is displayed on the LCD 5.

When the print button 13 is depressed in the state GN84 in which the playback mode is set, the program switches to the state GN85 in which the print mode is set. Immediately after the switch to the state GN85, the same image as an image played back on the LCD 5 in the state GN84 is displayed. When the shutter button 9 is depressed in the state GN84, the program switches to the state GN81 in which the single frame shooting mode is set.

In some cases, the digital camera 1 does not switch to the print mode even when the print button 13 is depressed at a specific timing. This point will be described later.

Also when the print button 13 is depressed in the state GN85 in which the print mode is set, a process of updating the print order contents or the like is performed as described above, but the setting of the print mode is maintained. In the case where the shutter button 9 is depressed in the state GN85, the program switches to the state GN81 in which the single frame shooting mode is set.

FIG. 17 is a flowchart showing the operation of an error check corresponding to the state ST41.

First, it is determined whether a captured image is stored in the memory card 90 or not (step ST51). In the case where a captured image is stored, the program advances to step ST52. In the case where a captured image is not stored, the program advances to step ST53.

In step ST52, a captured image of the largest frame number is designated and an image file (data) is read. After completion of the reading, the program switches to the state GN85 (FIG. 16) in which the print mode is set. Even when the print button 13 is depressed in step ST52, the depression of the print button 13 is ignored and the reading of a file is continued. In step ST52, an image file of the largest frame number is read in order to switch the digital camera 1 to the print mode. When it is assumed that an operation of depressing the print button 13 is accepted during the reading, the reading of the image file of the largest frame number has to be started again from the beginning and, as a result, processing time of switching the digital camera 1 to the print mode becomes long. Therefore, in step ST52 in which the digital camera 1 is being switched to the print mode, depression of the print mode 13 is ignored, thereby giving priority to the intention of the user to switch the digital camera 1 to the print mode and promptly switching the digital camera 1 to the print mode. A concrete method of ignoring depression of the print button 13 will be described later.

In step ST53, the mode (single frame shooting mode, continuous shooting mode or motion picture mode) which is set before the switch to the error check ST41 is stored.

In step ST54, a warning that “there is no image in memory card” is displayed on the LCD 5. After lapse of two seconds, in response to the depression of the execution (center) button 7e, print button 13 or mode switching button 11, the program returns to the mode before the switch stored in the step ST53.

By the error check operation, the digital camera 1 can be prevented from switching to the print mode in the case where there is no captured image in the memory card 90.

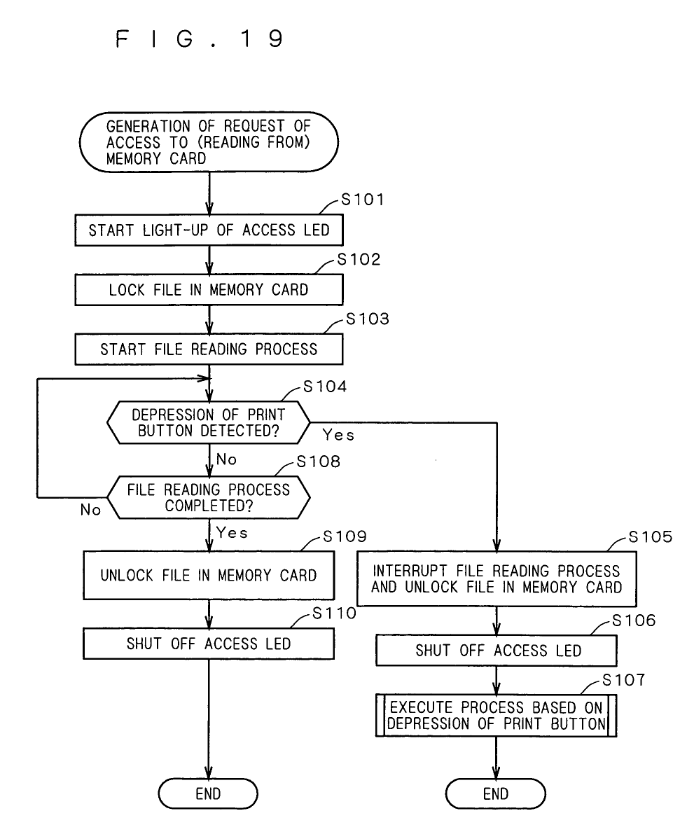

The process performed in the case where the print button 13 is depressed in each of the states of the digital camera 1 in the playback mode will be described with respect to each of the items (1) to (6) shown in FIG. 18.

(1) When the print button 13 is depressed in the state where the menu screen of the playback mode (hereinafter, also referred to as a “playback menu”) is being displayed, the program immediately switches to the print setting screen Gp (FIG. 7).

(2) When the print button 13 is depressed during a slide show, the slide show is interrupted and the program switches to the print setting screen Gp.

(3) When the print button 13 is depressed during playback of a motion picture, the motion picture playback is interrupted, and the program switches to the print setting screen Gp displaying the subsequent frame (still picture) of the motion picture presently being played back for the reason that printing cannot be designated for a motion picture. If the subsequent still picture does not exist, the frame (still picture) before the motion picture is displayed.

(4) When the print button 13 is depressed during a file access (reading) by frame advance, enlarge display, image process or the like, the program interrupts the file access and switches to the print setting screen Gp. In the case where the mode switch is being performed, priority is given to reading of data.

An operation flow of accepting an operation of depressing the print button 13 for switching the digital camera 1 to the print mode during a file access (reading) and switching the digital camera 1 to the print mode will now be described.

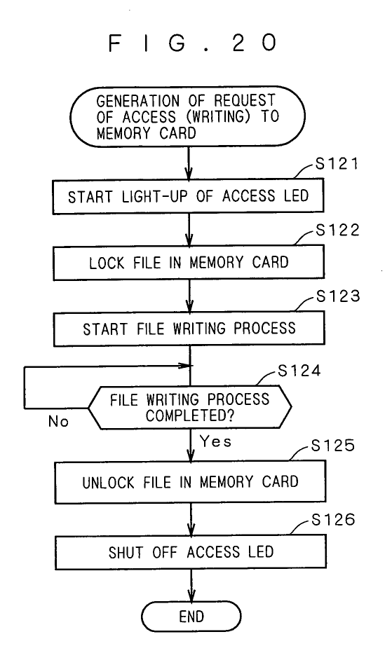

FIG. 19 is a flowchart showing the operation flow regarding the operation of a switch to the print mode during a file access (reading). First, when a request of a file access for reading a file in the memory card 90, that is, a file access (reading) to the memory card 90 is generated, the program advances to step S101.

In step S101, light-up of the access LED 19 for indicating that a file is being accessed starts, and the program advances to step S102.

In step S102, a state where other accesses to the file stored in the memory card 90 are interrupted, that is, a state where the file is locked is set, and the program advances to step S103. The overall controller 50 performs a file locking control.

In step S103, a process of reading the file corresponding to the file access (reading) requested at the start of the operation flow is started, and the program advances to step S104.

In step S104, it is determined whether the print button 13 has been depressed or not. If it is herein determined that the print button 13 has been depressed, the program advances to step S105. If it is not determined that the print button 13 has been depressed, the program advances to step S108.

In step S105, the file reading process is immediately interrupted, the state where the file in the memory card 90 is locked is cancelled, and the program advances to step S106. That is, a state in which various accesses to the file in the memory card 90 can be accepted is set.

In step S106, the access LED 19 indicating that the file is being accessed is shut off, and the program advances to step S107.

In step S1107, a process based on the depression of the print button 13, that is, switch to the print mode is executed, and the operation flow is finished. As described above, in the case where the print button 13 is depressed during the file reading process, the file reading process is immediately stopped, and the program switches to the print mode. Exceptionally, switch to the print setting screen during execution of a file access is permitted by the overall controller 50. This is because when a file access is made for the reading process, even if file reading operations conflict with each other, the file is not destroyed. Therefore, in this case, priority is given to the intention of the user to switch the digital camera 1 to the print mode, and the digital camera 1 is immediately switched to the print mode. As a result, print settings can be made easily and efficiently.

In step S108, it is determined whether the file reading process has been completed or not. If it is herein determined that the file reading process has been completed, the program advances to step S109. If it is not determined that the file reading process has been completed, the program returns to step S1104. That is, until the file reading process is completed, while permitting interruption of a switch to the print mode in response to depression of the print button 13, the file reading process is continued.

In step S109, the state where the file in the memory card 90 is locked is cancelled, and the program advances to step S110. That is, the state where various accesses to the file in the memory card 90 can be accepted is set.

In step S110, the access LED 19 indicating that a file is being accessed is shut off, and the operation flow is finished.

(5) Even when the print button 13 is depressed during a file access (writing) by an image process for creating a new image, a setting of copy, erase, or protect, updating of a print order file, or the like, the depression is ignored in order to prevent the file from being destroyed.

The operation of ignoring the depression of the print button 13 for switching the digital camera 1 to the print mode will now be described by using, as an example, an operation flow of ignoring depression of the print button 13 during a file access (writing).

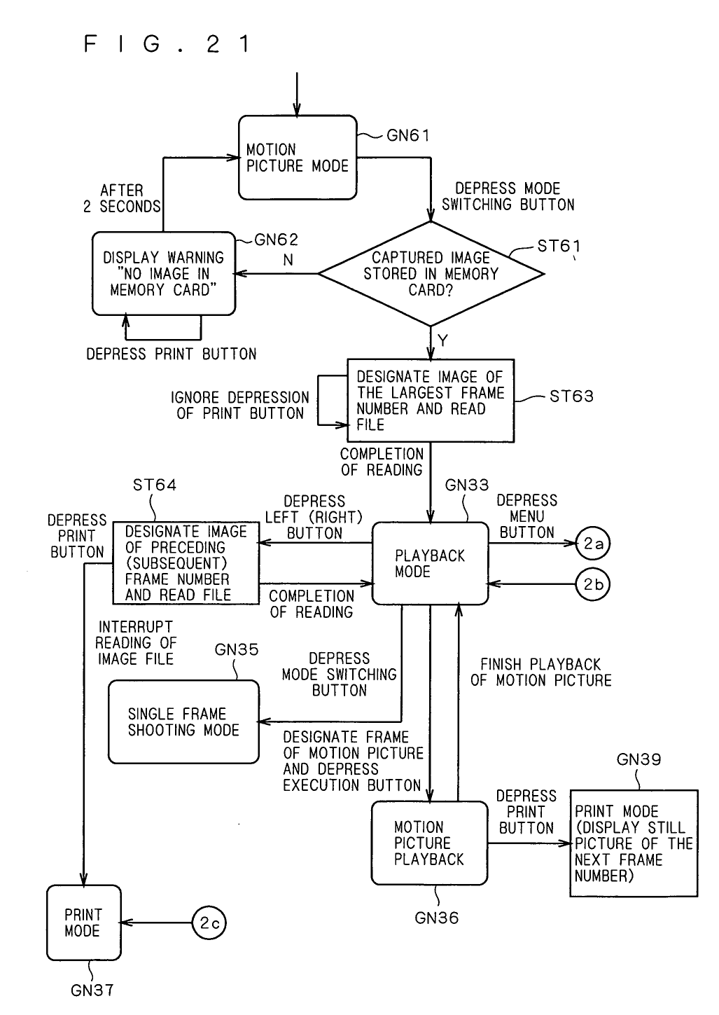

FIG. 20 is a flowchart showing the operation flow of ignoring depression of the print button 13 during a file access (writing). First, when a request of a file access for writing a file, specifically, for creating a file in the memory card 90 or updating a file in the memory card 90, that is, a file access (writing) to the memory card 90 is made, the program advances to step S121. In other words, when a file access request is made or start of execution of a file access is instructed, the program advances to step S121.

In step S121, light-up of the access LED 19 indicating that a file is being accessed starts, and the program advances to step S122.

In step S122, the digital camera 1 is set in a state where other accesses to a file recorded in the memory card 90 are interrupted, that is, a state where a file is locked, and the program advances to step S123. In other words, other accesses to the file are inhibited during a file writing process.

In step S123, the file writing process corresponding to the file access (writing) requested at the start of the operation flow is started, and the program advances to step S124.

In step S124, it is determined whether the file writing process has been completed or not. If it is herein determined that the file writing process has been completed, the program advances to step S125. If it is not determined that the file writing process has been completed, the determining operation in step S124 is repeated until the file writing process is finished.

In step S125, the state where a file in the memory card 90 is locked is cancelled, and the program advances to step S126. That is, a state where various accesses to a file in the memory card 90 can be accepted is set.

In step S126, the access LED 19 indicating that a file is being accessed is shut off, and the operation flow is finished.

When it is assumed that a file access for reading an image file is made in association with a switch to the print mode during the process for writing a file in the memory card 90, file accesses conflict with each other, and the file writing process is not performed accurately. For example, the writing operation on the file is interrupted, and there is the possibility that the file is destroyed substantially.

When a new file is created at the time of writing a file, the contents of the file management table FT shown in FIG. 4 are updated. Consequently, if a file access for reading an image file is made during updating of the file management table FT, the updating of the file management table FT is not performed accurately and, after that, an inconvenience such that the file in the memory card 90 cannot be accurately accessed may occur. That is, there is the possibility that accesses to a plurality of files in the memory card 90 become impossible.

In the digital camera 1 according to the preferred embodiment, therefore, other file accesses to a file in the memory card 90 are inhibited during a process of writing a file to the memory card 90 and depression of the print button 13 is ignored. As a result, an inconvenience such that the files and the file management table FT are substantially destroyed in association with conflicts of file accesses can be prevented.

In the case of making a setting of protection on an image file in the memory card 90, a writing process for changing the file attribute AT to a read only attribute (R) is performed. Consequently, depression of the print button 13 is ignored also during a process of making a setting of protection (protecting process).

As described above, first, when a request of a file access (writing) to the memory card 90 is made, it can be determined that start of execution of a file access to a file stored in the memory card 90 is instructed, and an operation flow shown in FIG. 20 is started. Specifically, the overall controller 50 determines whether a state where a request of a file access (writing) is made or a state where start of execution of a file access (writing) is instructed is set or not, thereby determining a state regarding execution of a file access (writing) to a file stored in the memory card 90. Next, on the basis of a result of determination of the state regarding execution of the file access, the overall controller 50 inhibits a switch to the print setting screen during a file access (writing process). After completion of execution of the file access (writing process), inhibition of the switch is cancelled and a state where a switch to the print setting screen is permitted is set. With such a configuration, for example, since confliction of file accesses can be prevented, an inconvenience such as destroy of a file can be prevented. As a result, the timing of a switch to the print setting screen can be optimized.

Also during a process of erasing an image file, an operation similar to the operation of ignoring depression of the print button 13 shown in FIG. 20 is performed. This is because it is contradictory to read an image file being subjected to an image file erasing process. Therefore, in this case, simultaneous occurrence of such contradictory operations is prevented. Particularly, during a process of erasing all of image files in the memory card 90 and a formatting process of erasing all of files, there is no target on which print settings are to be made, so that depression of the print button 13 is ignored. The operation flow of ignoring depression of the print button 13 in the case where an image file erasing process is performed is similar to that of FIG. 20 except that writing of files is replaced with erasing of files.

As described above, during execution of a file access which is made in a protecting process or an erasing process on a captured image recorded on the memory card 90, a switch to the print setting screen is inhibited by the overall controller 50. With such a configuration, a situation such that a file is destroyed due to confliction of file accesses can be prevented, and execution of contradictory operations such as reading of a captured image which is being erased can be prevented. That is, the timing of a switch to the print setting screen can be optimized.

As described above, during a switch to the print mode or playback mode from another mode, depression of the print button 13 is ignored. In this case, an operation similar to the operation of ignoring depression of the print button 13 shown in FIG. 20 is performed. In short, when a file access (reading) to the memory card 90 is made at the time of a mode switch, a switch to the print setting screen is inhibited by the overall controller 50.

At the time of a switch to the print mode or playback mode from another mode, a file access (reading) is made. If depression of the print button 13 is accepted during the mode switch and a captured image on which print settings are to be made is read from the beginning, the file reading process being performed becomes useless. Consequently, by regarding depression of the print button 13 as an erroneous operation at the time of a mode switch, a switch to the print setting screen is inhibited, and the file reading process being performed is prevented from becoming useless. That is, priority is given to the file reading process which is being currently performed. As a result, operationality can be improved.

(6) When the print button 13 is depressed during after-recording, the program interrupts the after-recording and, after completion of recording of sound up to the interruption, switches to the print setting screen Gp of a frame to be after-recorded.

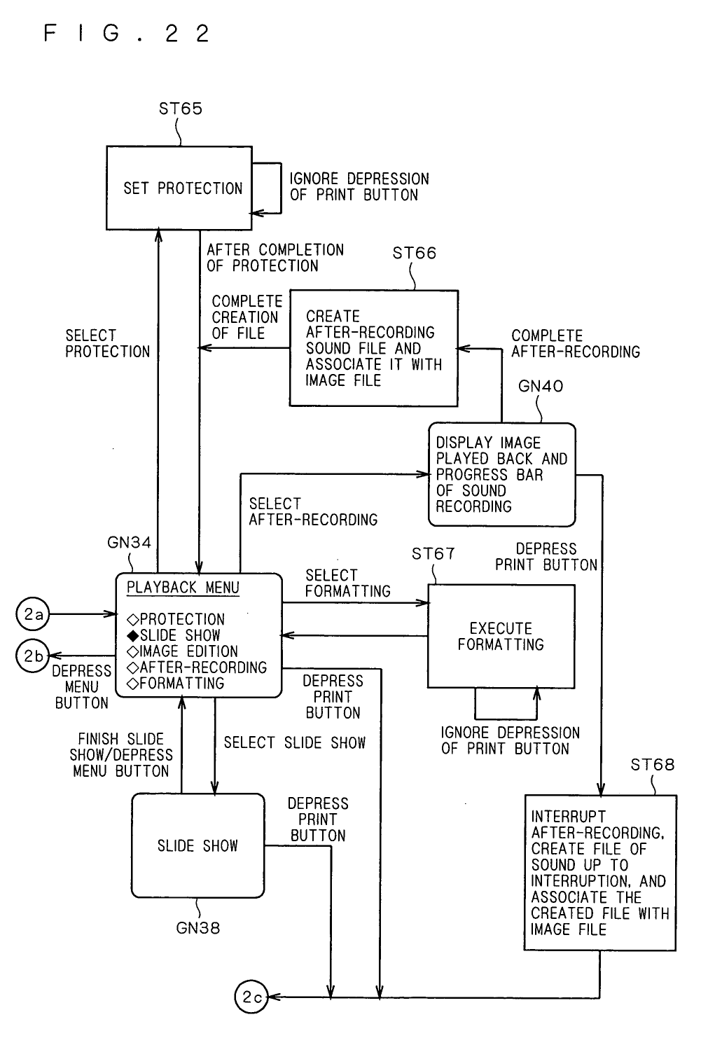

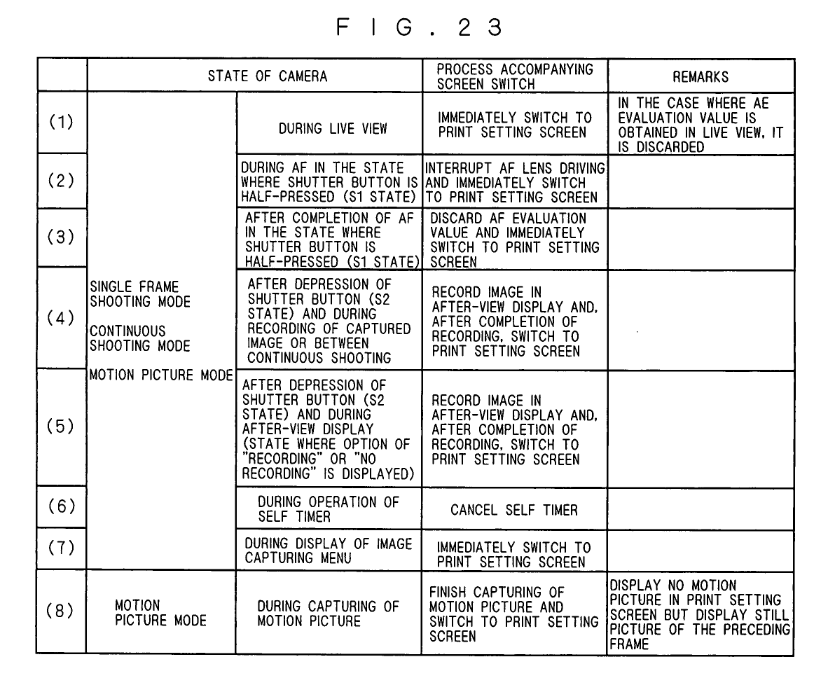

FIGS. 21 and 22 are diagrams for describing operations of the digital camera 1 in the playback mode. In the diagrams, blocks having reference symbols starting with GN indicate states of the digital camera, and blocks having reference symbols starting with ST indicate processes of the digital camera 1.

When the mode switching button 11 is depressed in a state GN61 in which the motion picture mode is set as shown in FIG. 21, a process ST61 of determining whether a captured image is stored in the memory card 90 or not is performed. If it is found in the process ST61 that the captured image is stored, a process ST63 of designating an image of the largest frame number and reading the image file is performed. After completion of the reading, the program switches to a state GN33 in which the playback mode of displaying the image of the frame number is displayed. Even in the case where the print button 13 is depressed while the process ST63 is performed, it is ignored and the reading process is continued. In this case, as described above, an operation similar to the operation of ignoring depression of the print button 13 shown in FIG. 20 is performed.

On the other hand, if it is found in the process ST61 that a captured image is not stored, the program switches to a state GN62 in which a warning of “there is no image in memory card” is displayed. After two seconds, the program switches to the state GN61 in which the motion picture mode is set. Even when the print button 13 is depressed in the state GN62, it is ignored.

When the left button 7c (or right button 7d) is depressed in the state GN33 in which the playback mode is set, a process ST64 of designating an image of the preceding (or subsequent) frame number and reading an image file is performed. After completion of the process ST64, the program switches to the state GN33 in which the playback mode displaying the read image file is set. In the process ST64, when the print button 13 is depressed, reading of an image file is interrupted, and the program switches to a state GN37 in which the print mode of displaying the image displayed immediately before the reading process is set.

In the case where the mode switching button 11 is depressed in the state GN33 in which the playback mode is set, the program switches to a state GN35 in which the single frame shooting mode is set. When the frame of a motion picture is designated and the execution (center) button 7e is depressed in the case where an image is displayed in the form of a thumbnail image in the state GN33, the program switches to a state GN36 of playing back the motion picture of the designated frames. When the print button 13 is depressed in this state GN36, the program switches to a state GN39 in which the print mode of displaying a still picture of the subsequent frame number is set.

When the menu button 8a is depressed in the state GN33 in which the playback mode is set, the program switches to a state GN34 in which the menu screen of the playback mode shown in FIG. 22 is displayed. When the menu button 8a is depressed, the program returns to the state GN33 in which the playback mode shown in FIG. 21 is set.

In the case where “protect” as a menu item is selected and the execution (center) button 7e is depressed in the state GN34 in which the playback menu is displayed as shown in FIG. 22, a process ST65 of setting protection is performed. After completion of the setting of protection, the program returns to the state GN34 in which the playback menu is displayed. Even in the case where the print button 13 is depressed during the protection setting process ST65, it is ignored and the protection setting is continued. In this case, as described above, the operation of ignoring depression of the print button 13 shown in FIG. 20 is performed.

In the case where “after-recording” as a menu item is selected and the execution (center) button 7e is executed in the state GN34 in which the playback menu is displayed, the program switches to a state GN40 displaying an image played back and a progress bar of sound recording. In the state GN40, when the after-recording is finished, a process ST66 of creating an after-recording sound file in the memory card 90 and associating the created after-recording sound file with an image file is performed. After completion of creation of the after-recording sound file, the program switches to the state GN34 displaying the playback menu. On the other hand, in the case where the print button 13 is depressed in the state GN40, after-recording is interrupted, a process ST68 of creating a sound file up to the interruption and associating the sound file with an image file of an image played back is performed. The program switches to the state GN37 (FIG. 21) in which the print mode of displaying the image played back is set.

In the case where “formatting” as a menu item is selected and the execution (center) button 7e is depressed in the state GN34 in which the playback menu shown in FIG. 22 is displayed, a process ST67 of executing formatting is executed. When the formatting is completed, the program returns to the state GN34 in which the playback menu is displayed. Even in the case where the print button 13 is depressed during the formatting process ST67, it is ignored and the formatting process is continued. In this case, as described above, the operation of ignoring depression of the print button 13 shown in FIG. 20 is performed.

In the case where “slide show” as a menu item is selected and the execution button 7e is depressed in the state GN34 in which the playback menu is displayed, the program switches to a state GN38 where the slide show is executed. In the case where the slide show is finished and the menu button 8a is depressed in the state GN38, the program returns to the state GN34 in which the playback menu is displayed. When the print button 13 is depressed in the state GN38, the program switches to the state GN37 (FIG. 21) in which the print mode of displaying the print setting screen is set.

When the print button 13 is depressed in the state GN34 in which the playback menu shown in FIG. 22 is displayed, the program switches to the state GN37 (FIG. 21) in which the print mode of displaying the print setting screen is set.

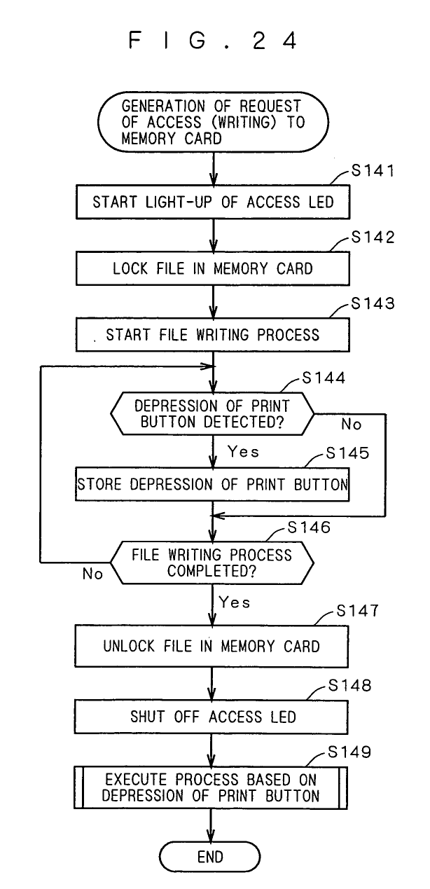

Although the relation between the playback mode and the print mode has been described above, in the following, the process performed when the print button 13 is depressed in each of the states of the digital camera 1 in the image capturing modes other than the playback mode, concretely, the single frame shooting mode, continuous shooting mode and motion picture mode will be described with respect to each of the items (1) to (8) shown in FIG. 23.

(1) When the print button 13 is depressed during live view display, the program immediately switches to the print setting screen Gp (FIG. 7). In the case where an AE evaluation value is obtained in a live view, it is discarded.

(2) When the shutter button 9 is half-pressed (S1 state) and the print button 13 is depressed during AF, the program interrupts the driving of the AF lens in the taking lens 2 and immediately switches to the print setting screen Gp.

(3) When the print button 13 is depressed after the shutter button 9 is half-pressed (S1 state) and AF is completed, the program discards an AF evaluation value obtained and immediately switches to the print setting screen Gp.

(4) After the shutter button 9 is depressed (S2 state) and during recording of a captured image or between image captures in the continuous shooting, by depression of the print button 13, an image stored in the RAM 50a is recorded and, after completion of recording, the program switches to the print setting screen Gp.

In this case, although a file access (writing) involved in a process of recording a captured image related to after-view is made, in consideration of operationality of the user, exceptionally, an operation different from the operation shown in FIG. 20 is performed. Concretely, even if the print button 13 is depressed during a file access, the digital camera 1 does not immediately switch to the print mode. After completion of the file access (writing), the digital camera 1 switches to the print mode. To be specific, depression of the print button 13 is stored and, after completion of the file access, the digital camera 1 immediately switches to the print mode.

The operation flow of temporarily storing depression of the print button 13 during a file access (writing) and, after completion of the file access, switching the digital camera 1 to the print mode will be described.

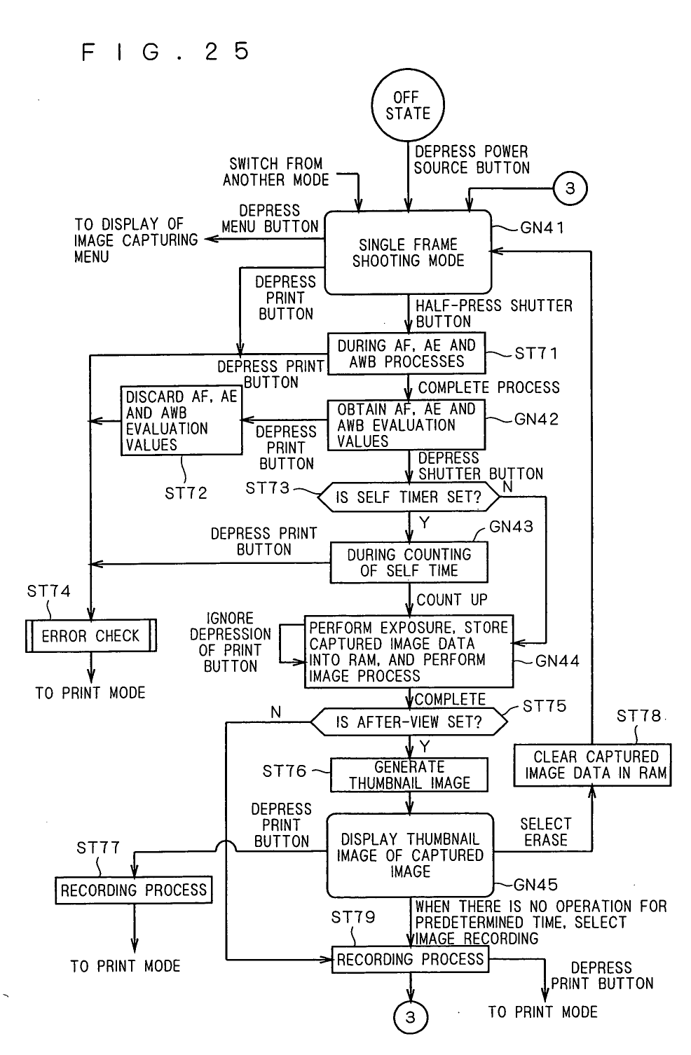

FIG. 24 is a flowchart showing the operation flow of temporarily storing depression of the print button 13 during a file access (writing) and, after completion of the file access, switching the digital camera 1 to the print mode. First, when a request of a file access (writing) for recording a captured image into the memory card 90 is made, the program advances to step S141.

In step S141, light-up of the access LED 19 indicating that a file is being accessed starts, and the program advances to step S142.

In step S142, a state in which other accesses to a file recorded in the memory card 90 are interrupted, that is, a state where a file is locked is set, and the program advances to step S143. In other words, other accesses to a file are inhibited during the file writing process.

In step S143, the file writing process corresponding to the file access (writing) requested at the start of the operation flow is started, and the program advances to step S144.

In step S144, it is determined whether the print button 13 is depressed or not. If it is herein determined the print button 13 is depressed, the program advances to step S145. If it is not determined that the print button 13 is depressed, the program advances to step S146.

In step S145, depression of the print button 13 is temporarily stored in the RAM 50a, and the program advances to step S146.

In step S146, it is determined whether the file writing process has been completed or not. If it is herein determined that the file writing process has been completed, the program advances to step S147. If it is not determined that the file writing process has been completed, the processes from step S144 to S146 are repeated until the file writing process is completed. During repetition of the processes from step S144 to S146, once it is determined in step S144 that the print button 13 is depressed and depression of the print button 13 is stored in step S145, it becomes unnecessary to perform the process in step S145 after that. Consequently, in step S144, it is always determined that the print button 13 has not been depressed.

In step S147, the state where the file in the memory card 90 is locked is cancelled, and the program advances to step S148. That is, the state where various accesses to the file in the memory card 90 can be accepted is set.

In step S148, the access LED 19 indicating that a file is being accessed is shut off, and the program advances to step S149.

In step S149, if depression of the print button 13 is stored in step S145, a process based on the stored contents (depression of the print button 13), that is, an operation of a switch to the print mode (including the error check process) is executed. Then, the operation flow is finished. In step S149, if depression of the print button 13 is not stored in step S145, no process is performed and the operation flow is finished.

As described above, first, when a request of a file access (writing) to the memory card 90 is made, it can be determined that a state where start of execution of an access to a file stored in the memory card 90 is instructed is set, and the operation flow shown in FIG. 24 is started. Specifically, the overall controller 50 determines whether the state where a request of a file access (writing) is made, that is, a state where start of execution of a file access (writing) is instructed is set or not, thereby determining the state regarding execution of a file access (writing) to a file stored in the memory card 90. After that, under control of the overall controller 50, on the basis of a result of determination of the state regarding execution of the file access, during execution of the file access, a switch to the print setting screen is inhibited, and depression of the print button 13 by the user can be temporarily stored as information (also referred to as information of depression). After completion of the file access, the display screen on the LCD 5 is switched to the print setting screen on the basis of the information of depression temporarily stored. With such a configuration, for example, conflict of file accesses can be prevented, so that an inconvenience such as destroy of a file can be prevented. Consequently, the timing of a switch to the print setting screen can be optimized. Since depression of the print button 13 by the user is not ignored but an operation based on the depression is performed, the digital camera having excellent operationality, in which an intention of the user is reflected as much as possible can be achieved.

Which one of the operation flows in FIGS. 20 and 24 is used can be determined by checking the contents of the file writing operation by the overall controller 50.

(5) During an after view display of displaying a captured image on the LCD 5 after the shutter button 9 is depressed (S2 state) (in the state where an option of “to record” or “not to record” is displayed), an image displayed as an after view is recorded by depressing the print button 13. After completion of the recording, the program switches to the print setting screen Gp. In this case, on assumption that the user has an intention of making print settings on the captured image corresponding to an after-view, the process of recording the captured image corresponding to an after-view is completed and, after that, the program switches to the print setting screen Gp regarding the after-view. As shown in FIG. 24, the operation of temporarily storing depression of the print button 13 and, after completion of the file access, switching to the print mode is performed.

(6) When the print button 13 is depressed during a self timer operation, the program cancels the self timer and switches to the print mode.

(7) When the print button 13 is depressed during display of the menu screen of the image capturing mode (hereinafter, also referred to as “image capturing menu”), the program immediately switches to the print setting screen Gp.

(8) When the print button 13 is depressed during capturing of a motion picture in the motion picture mode, the program finishes the motion picture capturing and switches to the print setting screen Gp. In the print setting screen, a captured motion picture is not displayed but a still image of the immediately preceding frame is displayed.

The operation of the digital camera 1 in the image capturing modes including the single frame shooting mode, continuous shooting mode and motion picture mode will be described below by using an operation in the single frame shooting mode as a representative example.

FIG. 25 is a diagram for describing the operation of the digital camera 1 in the single frame shooting mode. In the diagram, blocks having reference symbols starting with GN indicate the states of the digital camera, and blocks having reference symbols starting with ST show processes of the digital camera 1.

When the single frame shooting mode is set and the shutter button 9 is half-pressed in a state GN41 in which live view display is made, AF, AE and AWB processes ST71 are performed. After completion of the process, the program switches to a state GN42 in which AF, AE and AWB evaluation values are obtained. When the print button 13 is depressed in the state GN41 in which the single frame shooting mode is set or during the AF, AE and AWB processes ST71, an error check process ST74 similar to that shown in FIG. 17 is performed and the program switches to the print mode.

When the menu button 8a is depressed in the state GN41 in which the single frame shooting mode is set, the program switches to a state where the image capturing menu which will be described later is displayed.

When the print button 13 is depressed in the state GN42 where the AF, AE and AWB evaluation values are obtained, a process ST72 of discarding the AF, AE and AWB evaluation values is performed and, after that, the error check process ST74 is performed. On the other hand, when the shutter button 9 is depressed in the state GN42, a process ST73 of determining whether the self timer is set or not is performed. In the case where the self timer is set, the program switches to a self timer counting state GN43. On the other hand, in the case where the self timer is not set, the program switches to a state GN44 of performing exposure, storing captured image data into the RAM 50a, and performing an image process.

When the print button 13 is depressed in the state GN43 of counting the self timer, the program cancels the self timer and switches to the error check process ST74. On the other hand, when the self timer is counted up in the state GN43, the program switches to the state GN44 of performing exposure and the like.

Even when the print button 13 is depressed in the state GN44 of performing exposure and the like, it is ignored and the exposing process or the like is continued. After completion of the image process in the state GN44, the program switches to a process ST75 of determining whether after-view is set or not.

In the case where after-view is set in the determining process ST75, a process ST76 of generating a thumbnail image for display of the thumbnail image data SD (FIG. 4) is performed, and the program switches to a state GN45 of displaying the thumbnail image of a captured image. On the other hand, when the after-view is not set in the determining process ST75, a process ST79 of recording the captured image into the memory card 90 is performed and, after that, the program switches to the state GN41 in which the single frame shooting mode is set, and the live view display is made. When the print button 13 is depressed during the recording process ST79, the process of recording a captured image into the memory card 90 is performed and the program switches to the print mode. That is, as shown in FIG. 24, the process of temporarily storing depression of the print button 13 and, after completion of the file access, switching to the print mode is performed.

In the case where the print button 13 is depressed in the thumbnail image display state GN45, a process ST77 of recording a captured image into the memory card 90 is performed, and the program switches to the print mode. Also in this case, as shown in FIG. 24, the process of temporarily storing depression of the print button 13 and, after completion of the file access, switching to the print mode is performed.

In the case where there is no user's operation for predetermined time (for example, three seconds) or image recording is selected by the user in the thumbnail image display state GN45, the program switches to the recording process ST79.

In the case where erase of an image is selected in the thumbnail image display state GN45, the captured image data in the RAM 50a is cleared, and the program switches to the single frame shooting mode setting screen GN41 and performs live view display.

As described above, in the digital camera 1 according to the preferred embodiment of the present invention, by determining whether a request of a file access (writing) to the memory card 90 is made or not, the state regarding execution of a file access is determined. On the basis of the result of determination, during execution of a file access (writing) by an image process for creating a new image, copying an image, erasing an image, a setting of protect, or updating of a print order file, or the like, a switch to the print mode which is made in response to depression of the print button 13 is inhibited. As a result, for example, by preventing confliction of file accesses, an inconvenience such that a file is destroyed can be prevented. Therefore, the timing of a switch to the print setting screen can be optimized.

By determining the state regarding execution of a file access, a switch to the print mode which is performed in response to depression of the print button 13 is inhibited during execution of a file access. However, in some cases, depression of the print button 13 is temporarily stored and, after completion of a file access, the display screen on the LCD 5 is immediately switched to the print setting screen on the basis of the temporarily stored information. Also in the cases, for example, by preventing confliction of file accesses, an inconvenience such that a file is destroyed can be prevented. Therefore, the timing of a switch to the print setting screen can be optimized.

Modifications

Although the preferred embodiment of the present invention has been described above, obviously, the present invention is not limited to the above but various modifications can be applied.

For example, in the foregoing preferred embodiment, in the case where the print button 13 is depressed during a file access (writing) to the memory card 90, appropriately, depression of the print button 13 is ignored or the digital camera switches to the print mode after completion of the file access. However, the present invention is not limited to the above. For example, depression of the print button 13 may be always ignored during a file access (writing). It is also possible to always temporarily store depression of the print button 13 during a file access (writing) and immediately switch to the print mode after completion of the file access. Further, according to a design idea, appropriately, depression of the print button 13 during a file access (writing) may be ignored and the mode may be switched to the print mode immediately after completion of the file access. With such a configuration, both prevention of an inconvenience such that a file is substantially destroyed and ease of operation for the user can be realized.

In the foregoing preferred embodiment, a file access is made by writing/reading of a file to/from the memory card 90. Not only in the cases but also at the time of inserting the memory card 90 into a memory card insertion part, a file in the memory card 90 is accessed in order to accept the memory card 90. If depression of the print button 13 is accepted during an operation of accepting the memory card 90, since the operation of accepting the memory card 90 is not finished yet, a captured image on which print settings are to be made cannot be read. A situation such that the operation of accepting the memory card 90 has to be started again from the beginning may occur. In short, the reading process becomes useless.

Consequently, at the time of insertion of the memory card 90, depression of the print button 13 is regarded as an erroneous operation, and the overall controller 50 inhibits a switch to the print setting screen, thereby preventing the process of accepting the memory card 90 being performed from being wasted. In such a manner, as a result, a switch to the print mode according to the intention of the user can be executed in shorter time. Thus, ease of operation can be improved.

In the foregoing preferred embodiment, the display screen displayed on the LCD 5 is switched to the print setting screen in response to depression of the print button 13. The present invention is not limited to the configuration but may employ another configuration such that, in a state where a captured image is played back and displayed on the LCD 5 in the playback mode, the captured image played back and displayed can be printed on an external printer connected to the digital camera when the print button 13 is depressed.

In the case of such another configuration, in response to depression of the print button, image data in the memory card is read and transmitted to an external printer, so that a file in the memory card is accessed. Therefore, if the print button is depressed during a file access (writing), file accesses conflict with each other, and there is the possibility that the file is substantially destroyed. In the case of printing an image on an external printer, generally, a setting screen regarding print conditions (print condition setting screen) for setting the print size, the number of prints, and the like is displayed so as to be superimposed on a display image before image data is transmitted to the printer. Consequently, when a file in the memory card is being accessed (written), the display screen is prevented from being switched to the print condition setting screen in response to depression of the print button 13, thereby enabling confliction of file accesses to be prevented. That is, when a file in the memory card is being accessed (written), in a manner similar to the foregoing preferred embodiment, it is preferable to ignore depression of the print button or temporarily store depression of the print button and, after completion of the file access, make a file access for transmitting image data to the external printer. The state where the print condition setting screen is displayed can be also said as a state where the print setting screen for making print settings including a captured image on which print settings are to be made is displayed, because the print condition setting screen is superimposed on a captured image to be printed.

In the case of a digital camera in which the print condition setting screen is not displayed before image data is transmitted to a printer, during a file access (writing) to a memory card, in a manner similar to the foregoing preferred embodiment, it is preferable to ignore depression of the print button or temporarily store depression of the print button and, after completion of the file access, access a file for transmitting image data to an external printer.

In the foregoing preferred embodiment, the overall controller 50 determines whether a state in which a request of a file access is made, that is, a state where start of execution of a file access is instructed is set or not, thereby determining the state regarding execution of an access to a file stored in the memory card 90. The present invention is not limited to the preferred embodiment. For example, by determining that the state where a file access is made is set simultaneously with start of a process of writing a file corresponding to a file access request, the state regarding execution of an access to a file stored in the memory card 90 can be determined. In the case where it is determined that the file writing process is started and a file access is executed, under control of the overall controller 50, a switch to the print setting screen, which is made in response to depression of the print button 13 can be inhibited.

While the invention has been shown and described in detail, the foregoing description is in all aspects illustrative and not restrictive. It is therefore understood that numerous modifications and variations can be devised without departing from the scope of the invention.

1. A digital camera capable of setting a print condition on a captured image which is stored in a storage medium, comprising:
a display part capable of displaying said captured image;
a manual operation part which accepts a manual operation for switching a camera status from a current operation mode to a print mode for setting a print condition on said captured image; and
a controller which switches a status of said display part from a current mode to a print condition setting mode in response to said manual operation, wherein said print condition setting mode is such that said captured image is displayed on said display part together with an information element for designating said print condition for said captured image,
said controller comprising
a first control element operable to determine whether or not a file access for a process for other than said print condition setting mode is being executed to a file including said captured image in said storage medium, and
a second control element operable to inhibit a switch of the status of said display part to said print condition setting mode during execution of said file access.

2. The digital camera according to claim 1, wherein
said first control element detects a request of said file access to determine said file access is being executed or not.

3. The digital camera according to claim 1, wherein
said first control element detects a file access process having started in response to a request of said file access to determine said file access is being executed or not.

4. The digital camera according to claim 1, wherein
said second control element permits a switch of the status of said display part to said print condition setting mode when said file access is being executed for reading said captured image stored in said storage medium.

5. The digital camera according to claim 1, wherein
said file access is being executed for erasing said captured image or protecting said captured image stored in said storage medium.

6. The digital camera according to claim 1, further comprising:
a mode setting member capable of accepting a manual operation to switch a camera status among a plurality of operation modes, said plurality of operation modes including an image capturing mode for capturing an image of a subject and a playback mode for reproducing a stored image on said display part, wherein
said file access is made when said camera status is switched, in response to a manual operation of said mode setting member, from a first mode included in said plurality of operation modes to a second mode which is also included in said plurality of operation modes but is different from said first mode.

7. The digital camera according to claim 1, wherein
said storage medium is detachable from said digital camera, and said file access is made in response to insertion of said storage medium into said digital camera.

8. A digital camera capable of setting a print condition on a captured image which is stored in a storage medium, comprising:
a display part capable of displaying said captured image;
a manual operation part which accepts a manual operation for switching a camera status from a current operation mode to a print mode for setting a print condition on said captured image; and
a controller which switches a status of said display part from a current mode to a print condition setting mode in response to said manual operation, wherein said print condition setting mode is such that said captured image is displayed on said display part together with an information element for designating said print condition for said captured image,
said controller comprising
a first control element operable to determine whether or not a file access for a process for other than said print condition setting mode is being executed to a file including said captured image in said storage medium,
a second control element operable to inhibit a switch of the status of said display part to said print condition setting mode during execution of said file access,
a third control element operable to store said manual operation, and
a fourth control element operable to detect completion of said file access, and then switch the status of said display part to said print condition setting mode in response to said manual operation stored.

9. The digital camera according to claim 8, wherein
said first control element detects a request of said file access to determine said file access is being executed or not.

10. The digital camera according to claim 8, wherein
said first control element detects a file access process having started in response to a request of said file access to determine said file access is being executed or not.

11. The digital camera according to claim 8, wherein
said second control element permits a switch of the status of said display part to said print condition setting mode when said file access is being executed for reading said captured image stored in said storage medium.

12. The digital camera according to claim 8, wherein
said file access is being executed for erasing said captured image or protecting said captured image stored in said storage medium.

13. The digital camera according to claim 8, further comprising:
a mode setting member capable of accepting a manual operation to switch a camera status among a plurality of operation modes, said plurality of operation modes including an image capturing mode for capturing an image of a subject and a playback mode for reproducing a stored image on said display part, wherein
said file access is made when said camera status is switched, in response to a manual operation of said mode setting member, from a first mode included in said plurality of operation modes to a second mode which is also included in said plurality of operation modes but is different from said first mode.

14. The digital camera according to claim 8, wherein
said storage medium is detachable from said digital camera, and said file access is made in response to insertion of said storage medium into said digital camera.

15. A digital camera capable of transmitting a captured image which is stored in a storage medium to a printer connected to said digital camera to print said captured image with said printer, comprising:
a display part capable of displaying said captured image;
a manual operation part which accepts an instruction related to an image printing process;
a mode setting member which sets a playback mode for reproducing a captured image which is stored in said storage medium onto said display part; and
a controller which transmits said captured image reproduced on said display part to said printer in response to said instruction related to said image printing process in said playback mode which is set with said mode setting member,
said controller comprising
a first control element operable to determine whether or not a first file-access is being executed to a file including said captured image in said storage medium, and
a second control element operable to inhibit a second file-access for transmitting said captured image to said printer during execution of said first file-access.

16. The digital camera according to claim 15, wherein
said controller further comprises
a third control element operable to store said instruction related to said image printing process, and
a fourth control element operable to detect completion of said first file-access, and then execute a new file access for transmitting said captured image to said printer in response to said instruction related to said image printing process.

17. A digital camera, comprising:
an image capturing part which obtains an captured image;
a digital file generator which generates a digital file including said captured image and stores said digital file in a storage device;
an instruction element capable to accept an instruction related to a printing process of said captured image; and
an interlock controller which prevents interference between a first file-access and a second file-access to said digital file stored in said storage device, wherein
said first file-access has started prior to said instruction, and
said second file-access is requested in response to said instruction.

18. The digital camera according to claim 17, further comprising:
an exceptional controller which disenables said interlock controller when said second file-access is being executed for reading said captured image without changing nor deleting said digital file.

19. A digital camera, comprising:
an image capturing part which obtains an captured image;
a digital file generator which generates a digital file including said captured image and stores said digital file in a storage device;
an instruction element capable to accept an instruction related to a printing process of said captured image;
a detector which detects a first file-access to said digital file stored in said storage device; and
a controller which postpones a second first-file access to said digital file until completion of said first file-access, wherein said first file-access has started prior to said instruction, and
said second file-access is requested in response to said instruction.
